(19) United States
(12) Patent Application Publication
(10) Pub. No.: US 2025/0298861 A1
(43) Pub. Date: Sep. 25, 2025

(54) ACCELERATION UNIT CONFIGURED FOR MULTI- DIMENSIONAL BLOCK-SCALED MATRICES

(71) Applicant: XILINX, INC., San Jose, CA (US)

(72) Inventor: Ephrem Wu, San Mateo, CA (US)

(21) Appl. No.: 18/616,001

(22) Filed: Mar. 25, 2024

(51) Int. Cl. G06F 17/16; G06F 5/01

(52) U.S. Cl. CPC G06F 17/16; G06F 5/01

(57) ABSTRACT

To perform matrix multiplication operations for one or more applications, a processing system includes an acceleration unit (AU) having a block-scaled dot-product circuitry configured to multiply a first matrix by a second matrix. To this end, the block-scaled dot-product circuitry first partitions the first matrix into one or more multi-dimensional scaled blocks and the second matrix also into one or more multi-dimensional scaled blocks. The block-scaled dot-product circuitry next determines dot products of respective portions of the first matrix and corresponding portions of the second matrix using the multi-dimensional scaled blocks of the matrices and then combines these dot products to determine the dot product of the first matrix and the second matrix.

### BACKGROUND

Some processing systems are configured to execute applications that require matrix multiplication operations to be performed, such as machine-learning applications, neural network applications, and the like. To perform such matrix multiplication operations, the processing systems include processors configured to first partition each matrix to be multiplied into either one or more one-dimensional row-wise scaled blocks or one or more one-dimensional column-wise scaled blocks. These one-dimensional scaled blocks each include two or more consecutive elements along a row-wise direction or a column-wise direction, respectively, of a matrix to be multiplied. Further, the elements within each one-dimensional scaled block are in a scaled representation so as to reduce the size of the one-dimensional scaled blocks. To then multiply the matrices, the processors determine dot products of one-dimensional row-wise scaled blocks of a first matrix and one-dimensional column-wise scaled blocks of a second matrix.

Further, certain applications executed by these processing systems require operations to be performed where a matrix is on the left side of the operand for a first multiplication and on the right of the operand for a second multiplication. However, due to the nature of matrix multiplication, a matrix on the left side of the operand must be partitioned into one-dimensional row-wise scaled blocks and a matrix on the right side of the operant must be partitioned into one-dimensional column-wise blocks. As such, because the processing systems partition the matrices before they are partitioned into either one-dimensional row-wise scaled blocks or one-dimensional column-wise scale blocks before multiplication occurs, the same partitioned matrix cannot be used for the first multiplication where the matrix is on the left side of the operand for the second multiplication where the matrix is on the second side of the operand. Similarly, certain applications executed by these processing systems require that one or more matrices be transposed before they are multiplied. However, because each matrix is partitioned into either one-dimensional row-wise scaled blocks or one-dimensional column-wise scale blocks before multiplication occurs, transposing a matrix increases the risk that the transposed matrix cannot be multiplied with another matrix. For example, transposing a matrix partitioned into one-dimensional row-wise scaled blocks results in a transposed matrix partitioned into one-dimensional column-wise scaled blocks which cannot be multiplied with another matrix partitioned into one-dimensional column-wise scaled blocks and cannot be used on the left side of the operand.

To accommodate these conditions where a partitioned matrix cannot be used on a certain side of the operand or where the partitioned matrix can be multiplied by another matrix due to being transposed, some processing systems generate two partitioned versions of one or more of the matrices to be multiplied. That is to say, the processing systems generate a first version of the matrix partitioned into one-dimensional row-wise scaled blocks and a second version of the matrix partitioned into one-dimensional column-wise blocks. The processing versions then use either the first or second partitioned version of the matrix based on which side of the operand the matrix is placed and whether the matrix is to be transposed. However, generating two partitioned versions of a matrix increases the memory footprint and processing resources needed to perform the matrix multiplication and negatively impacts the processing efficiency of the processing system.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system having an acceleration unit (AU) configured for multi-dimensional block-scaled matrix multiplication, in accordance with some implementations.

FIG. 2 is a block diagram of an example block-scaled dot-product unit, in accordance with some implementations.

FIG. 3 is a diagram of example matrices partitioned into one-dimensional scaled blocks, in accordance with some implementations.

FIG. 4 is a block diagram of an example configuration for block-scaled dot-product circuitry to handle one-dimensional block-scaled matrix multiplication, in accordance with some implementations.

FIG. 5 is a block diagram of an example row of the first configuration for one-dimensional block-scaled matrix multiplication, in accordance with some implementations.

FIG. 6 is a diagram of example matrices partitioned into multi-dimensional scaled blocks, in accordance with some implementations.

FIG. 7 is a block diagram of an example configuration for block-scaled dot-product circuitry to handle multi-dimensional block-scaled matrix multiplication, in accordance with some implementations.

FIG. 8 is a block diagram of an example column of the second configuration for multi-dimensional block-scaled matrix multiplication, in accordance with some implementations.

FIG. 9 is a block diagram of an example scaling factor distribution circuitry, in accordance with some implementations.

FIG. 10 is an example method for performing multi-dimensional block-scaled matrix multiplication at a block-scaled dot-product circuitry, in accordance with some implementations.

### DETAILED DESCRIPTION

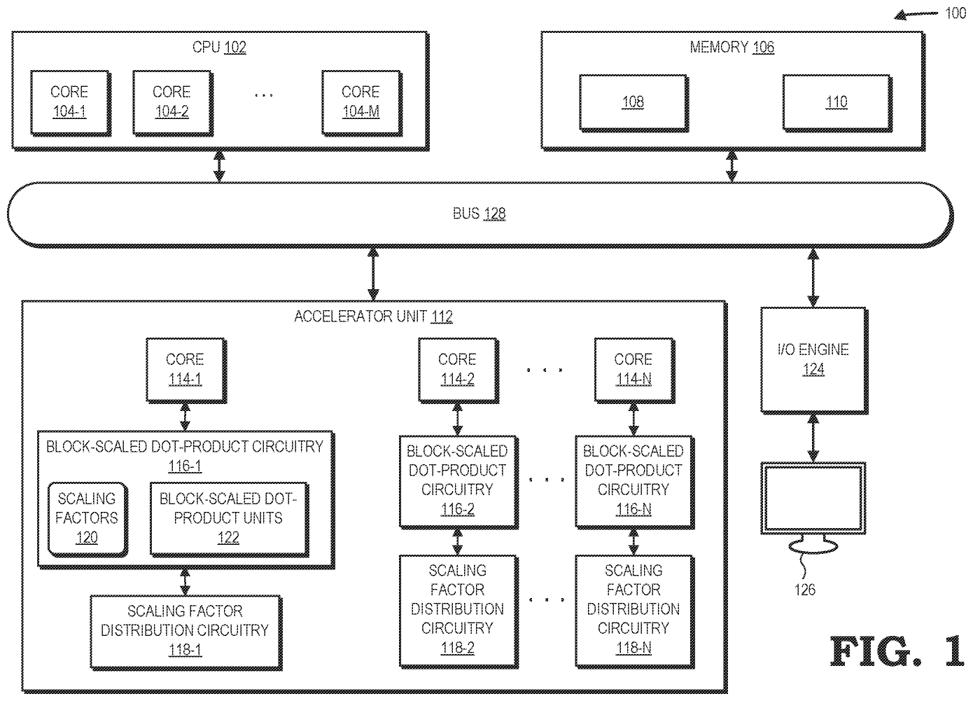

Some applications, such as machine-learning applications, neural network applications, radar applications, and the like, when executed by a processing system, require matrix multiplication to be performed. That is to say, these applications require the processing system to determine the dot product of a first matrix and a second matrix. To this end, FIGS. 1 to 10 herein are directed to a processing system that includes an acceleration unit (AU) configured to perform the multiplication of block-scaled matrices. To perform multiplication of block-scaled matrices, the AU includes one or more processor cores each including or otherwise connected to a block-scaled dot-product circuitry. Such a block-scaled dot-product circuitry, for example, is configured to first partition each matrix to be multiplied into one or more scaled blocks. Each scaled block includes a scaled representation of two or more successive elements within a matrix in one or more directions. As an example, based on instructions received from an application, block-scaled dot-product circuitry divides a first and second matrix to be multiplied into one or more one-dimensional scaled blocks. These one-dimensional scaled blocks each include two or more successive elements within a matrix in a first direction (e.g., row-wise) or in a second direction (e.g., column-wise). To multiply the first matrix by the second matrix using such one-dimensional scaled blocks, block-scaled dot-product circuitry partitions the first matrix into one or more one-dimensional scaled blocks in a first direction and the second matrix into one or more one-dimensional scale blocks in a second direction. The block-scaled dot-product circuitry then multiplies the first matrix by the second matrix by determining dot products of each one-dimensional scaled block of the first matrix with a corresponding one-dimensional scaled block of the second matrix.

However, certain applications, when executed by the processing system, create conditions where two versions of a matrix partitioned into one-dimensional scaled blocks must be produced. For example, some applications require operations that have a first multiplication where a matrix is on a first side (e.g., left side) of the operand and a second multiplication where the matrix is on a second side (e.g., right side) of the operand. Because a matrix partitioned into one-dimensional blocks in a first direction can only be used on one side of the operand (e.g., cannot be used on both sides of the operand), the processing system generates a first partitioned version of the matrix (the matrix partitioned into one-dimensional blocks in the first direction) to be used for the first multiplication and a second partitioned version of the matrix (the matrix partitioned into one-dimensional blocks in a second direction) to be used for the second multiplication. As another example, certain applications, such as some neural network applications, require that a matrix be transposed before it is multiplied. Transposing a matrix partitioned into one-dimensional scaled blocks changes the blocking such that the matrix changes from being partitioned into one-dimensional scaled blocks in a first direction to being partitioned into one-dimensional scaled blocks in a second direction. As such, transposing a matrix partitioned into one-dimensional scaled blocks in a first direction produces a matrix partitioned into one-dimensional scaled blocks in a second direction which cannot be multiplied with other matrices partitioned into one-dimensional scaled blocks in the second direction and cannot be used on a certain side of the operand. To accommodate the matrix being transposed, the processing system generates a first partitioned version of the matrix (the matrix partitioned into one-dimensional blocks in the first direction) to be used when the matrix is not transposed and a second partitioned version of the matrix (the matrix partitioned into one-dimensional blocks in a second direction) to be used when the matrix is transposed.

To help avoid conditions where multiple partitioned versions of a matrix are required, block-scaled dot-product circuitry is also configured to partition each matrix to be multiplied into one or more multi-dimensional scaled blocks. These multi-dimensional scaled blocks, for example, each include two or more successive elements within a matrix in a first direction (e.g., row-wise) and two or more successive elements within a matrix in a second direction (e.g., column-wise). To multiply the first matrix by the second matrix using such multi-dimensional scaled blocks, block-scaled dot-product circuitry partitions a first matrix into one or more multi-dimensional scaled blocks each including elements from two or more rows of the first matrix. The block-scaled dot-product circuitry also partitions a second matrix into one or more multi-dimensional scaled blocks each including elements from a column of the second matrix. The block-scaled dot-product then multiplies the first matrix by the second matrix by determining dot products of one or more multi-dimensional scaled blocks of the first matrix that include elements from two or more rows of the first matrix with one or more multi-dimensional scaled blocks of the second matrix that include elements from a first column of the second matrix. That is to say, based on the multi-dimensional scaled blocks of the first and second matrices, the block-scaled dot-product circuitry first determines dot products for each row of the first matrix and the first column of the second matrix. After determining such dot products, the block-scaled dot-product circuitry determines dot products for each row of the first matrix and each other column of the second matrix until the dot product of the first and second matrices is determined. In this way, the block-scaled dot-product circuitry is configured to multiply matrices using multi-dimensional scaled blocks which helps avoid conditions where multiple partitioned versions of a matrix are required. For example, due to the matrices being partitioned into multi-dimensional scaled blocks, the matrices are enabled to be placed on either side of the operand and are enabled to be multiplied by another matrix partitioned into multi-dimensional scaled blocks, reducing conditions where multiple partitioned versions of a matrix are required

Additionally, the block-scaled dot-product circuitry includes a first configuration configured to perform the multiplication of matrices partitioned into one-dimensional scaled blocks and as second configuration configured to perform the multiplication of matrices partitioned into multi-dimensional scaled blocks. For example, the AU is configured to switch the block-scaled dot-product circuitry based on instructions from one or more applications. As an example, based on the instructions indicating that matrices are to be partitioned into one-dimensional scaled blocks, the AU switches the block-scaled dot-product circuitry to a first configuration configured to perform the multiplication of matrices partitioned into one-dimensional scaled blocks. Likewise, based on the instructions indicating that matrices are to be partitioned into multi-dimensional scaled blocks, the AU switches the block-scaled dot-product circuitry to a second configuration configured to perform the multiplication of matrices partitioned into multi-dimensional scaled blocks. In this way, the AU is configured to perform multiplication for matrices partitioned into either one-dimensional or multi-dimensional blocks, helping expand the utility of the processing system while also reducing the need for other hardware in the processing system.

FIG. 1 is a block diagram of a processing system 100 including an AU configured for multi-dimensional block-scaled matrix multiplication, in accordance with some implementations. In implementations, processing system 100 is implemented within one or more servers, databases, cloud-based devices, personal computers, laptops, drones, mobile devices, or the like and includes or has access to memory 106 or other storage component implemented using a non-transitory computer-readable medium, for example, a dynamic random-access memory (DRAM). In some implementations, memory 106 is implemented using other types of memory including, for example, static random-access memory (SRAM), nonvolatile RAM, and the like. Further, memory 106, according to some implementations, includes an external memory implemented external to the processing units implemented in the processing system 100. The processing system 100 also includes a bus 128 to support communication between components (e.g., CPU 102, AU 112, memory 106) implemented in the processing system 100. Some implementations of processing system 100 include other buses, bridges, switches, routers, and the like, which are not shown in FIG. 1 in the interest of clarity. For example, in some implementations, processing system 100 includes a data fabric including bus 128 and configured to support communication between the components of processing system 100.

According to implementations, processing system 100 is configured to execute one or more applications 108 such as compute applications, graphics applications, machine-learning applications, neural network applications, artificial intelligence applications, radar applications, or any combination thereof, to name a few. In implementations, some applications 108 (e.g., compute applications, machine-learning applications, neural-network applications, artificial intelligence applications, radar application applications), when executed by processing system 100, cause processing system 100 to perform one or more computations such as machine-learning computations, neural network computations, databasing computations, sequencing computations, modeling computations, forecasting computations, or the like. Further, other applications (e.g., graphics applications), when executed by processing system 100, cause processing system 100 to render a scene including one or more graphics objects within a screen space and, for example, display them on a display 126.

To help execute applications 108, processing system 100 includes AU 112. AU 112, for example, is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. In implementations, AU 112 performs one or more commands, instructions, draw calls, or any combination thereof indicated in an application 108. For example, for certain applications, such as compute applications, machine-learning applications, neural network applications, artificial intelligence applications, and the like, AU 112 performs one or more commands, instructions, or both so as to generate one or more results for one or more computations (e.g., machine-learning computations, neural network computations, databasing computations, sequencing computations, modeling computations, forecasting computations). As another example, for graphics applications, AU 112 performs one or more commands, instructions, draw calls, or any combination thereof so as to render images according to one or more graphics applications for presentation on display 126. To perform commands, instructions, draw calls, or any combination thereof for one or more applications 108, AU 112 implements a plurality of processor cores 114-1 to 114-N that execute instructions concurrently or in parallel. In some implementations, one or more of the processor cores 114 each operate as one or more compute units (e.g., SIMD units) that perform the same operation on different data sets. Though in the example implementation illustrated in FIG. 1, AU 112 includes three processor cores (114-1, 114-2, 114-N) representing an N number of cores, the number of processor cores 114 implemented in AU 112 is a matter of design choice. As such, in other implementations, AU 112 can include any number of processor cores 114. The processor cores 104 execute instructions such as program code 110 (e.g., machine-learning code, neural network code) stored in memory 106, and AU 112 stores data in memory 106 such as the results of the executed instructions.

In some implementations, one or more applications 108 require matrix multiplication to be performed in order to determine results for one or more computations, render a scene, or both. As an example, certain machine-learning applications, neural network applications, radar applications, or any combination thereof require AU 112 to perform matrix multiplication (e.g., dot products) in order to determine results for one or more computations. To this end, each processor core 114 of AU 112 includes or is otherwise connected to a corresponding instance of block-scaled dot-product circuitry 116. Though the example implementation presented in FIG. 1 presents each processor core 114 as including or otherwise connected to a respective single instance of block-scaled dot-product circuitry (116-1, 116-2, 116-M), in other implementations, each processor core 114 can include or otherwise be connected to any number of instances of block-scaled dot-product circuitry 116. As an example, in some implementations, two or more processor cores 114 are each connected to the same instance of block-scaled dot-product circuitry 116 while in other implementations, two or more processor cores 114 are each connected to different instances of block-scaled dot-product circuitry 116. According to implementations, each instance of block-scaled dot-product circuitry 116 is configured to determine a dot product of two matrices.

To determine a dot product of two matrices, a block-scaled dot-product circuitry 116 (e.g., an instance of block-scaled dot-product circuitry 116) is first configured to partition each matrix to be multiplied into one or more scaled blocks. Such scaled blocks, also referred to herein as “native blocks,” include a distinct grouping of two or more neighboring elements within a matrix to be multiplied each associated with a corresponding scaling factor 120. As an example, in some implementations, a native block includes a one-dimensional grouping of two or more neighboring elements within a matrix such that the block includes two or more successive elements in a first direction (e.g., row) of the matrix or a second direction (e.g., column) of the matrix with each element of the block being associated with a scaling factor 120. Such a native block including a one-dimensional grouping (e.g., one-dimensional scaled block) is, in some implementations, expressed as a pair (xₛ, x_{b}) wherein xₛ represents a scaling factor 120 that is a real number and x_{b} represents a base vector with real numbers such that:

$$( {x}_{s} , {x}_{b} ) = {x}_{s} * {x}_{b} , {x}_{s} ∈ ℝ , {x}_{b} ∈ {ℝ}^{B} \qquad [ EQ1 ]$$

Wherein B represents the size of the base vector (e.g., size of the native block). That is to say, B represents the number of matrix elements within the native block.

When a matrix is partitioned into one-dimensional scaled blocks, the matrix is only partitioned in a first direction (e.g., by row) or a second direction (e.g., by column). Due to the matrix only being partitioned (e.g., blocked) in one direction (e.g., a first direction), the matrix can only be placed on a certain side (e.g., right side, left side) of the operand for a multiplication operation and can only be multiplied by a matrix partitioned in a different direction (e.g., a second direction). However, some applications 108 require operations that include a first multiplication where a matrix is on a first side (e.g., left side) of the operand and a second multiplication where the matrix is on a second side (e.g., right side) of the operand. Under such conditions, a matrix partitioned in one direction cannot be used for both the first multiplication and the second multiplication. As such, according to some implementations, to perform the first multiplication where the matrix is on the first side of the operand and a second multiplication where the matrix is on a second side of the operand, block-scaled dot-product circuitry 116 is configured to generate two partitioned versions of the matrix. A first version of the matrix partitioned in a first direction to be used for the first multiplication and a second version of the matrix partitioned in a second direction to be used for the second multiplication. Additionally, some applications, such as machine-learning applications, neural network applications, radar applications, or the like, are likely to create conditions where a first matrix blocked in a first direction cannot be multiplied by a second matrix blocked in a second direction. As an example, once the matrices are blocked in their respective directions by block-scaled dot-product circuitry 116, a neural network application 108, in some implementations, requires that a first matrix blocked in a first direction be transposed such that first matrix is now blocked in a second direction. The neural network application 108 then requires that the transposed matrix (e.g., transposed first matrix) be multiplied by a second matrix also blocked in the second direction. In some implementations, to accommodate these conditions, block-scaled dot-product circuitry 116 is configured to generate a second version of the first matrix originally blocked in the second direction which is then transposed and multiplied by the second matrix. However, generating two partitioned versions of a matrix increases the memory footprint and processing resources needed to multiply the matrix, lowering the processing efficiency of the processing system 100.

As such, in implementations, block-scaled dot-product circuitry 116 is configured to partition each matrix to be multiplied into one or more multi-dimensional native blocks (e.g., multi-dimensional scaled blocks). These multi-dimensional native blocks each include a multi-dimensional (e.g., two-dimensional) grouping of neighboring elements within a matrix such that the block includes two or more successive elements within a row of the matrix and two or more successive elements in a column of the matrix with each element in the multi-dimensional scaled block being associated with a corresponding scaling factor 120. A native block including a multi-dimensional grouping (e.g., multi-dimensional scaled block) is, in some implementations, expressed as a pair (xₛ, X_{b}) wherein xₛ represents a scaling factor 120 that is a real number and X_{b} represents a two-dimensional base matrix with real numbers such that:

$$( {x}_{s} , {x}_{b} ) = {x}_{s} * {x}_{b} , {x}_{s} ∈ ℝ , {X}_{b} ∈ {ℝ}^{{B}_{0} * {B}_{1}} \qquad [ EQ2 ]$$

Wherein B₀ represents the size of the base matrix (e.g., size of the native block) in a first direction (e.g., the number of matrix elements in a row within the native block) and B₁ represents the size of the base matrix in a second direction (e.g., the number of matrix elements in a column within the native block). In implementations, due to the multi-dimensional nature of the multi-dimensional native blocks, a matrix partitioned into multi-dimensional native blocks is enabled to be placed on either side of the operand during a multiplication operation. As such, only a single partitioned version of the matrix is needed for multiplication operations where the matrix is on a first side (e.g., left side) of the operand and multiplication operations wherein the matrix is on a second side of the operand (e.g., right side). Due to only a single partitioned version of the matrix is needed for these multiplication operations, the memory footprint required to multiply the matrix is reduced. Further, a matrix partitioned into multi-dimensional native blocks is enabled to be multiplied by another partitioned into multi-dimensional native blocks even when transposed. Due to this, only a single partitioned version of the matrix is needed even when the matrix is to be transposed, again reducing the memory footprint needed to multiply the matrix.

According to implementations, the scaling factor 120 associated with the matrix elements of a one-dimensional or multi-dimensional scaled block represents a value by which to multiply each matrix element of a scaled block to produce a non-scaled block. That is to say, a scaling factor 120 represents a number factored out of each matrix element within a scaled block. By factoring the scaling factor 120 out of each matrix element within a scaled block, the matrix elements within the scaled block are able to be written with less precision (e.g., less significant figures) which reduces the memory footprint of the scaled block.

In some implementations, the size of a native block (e.g., the number of matrix elements in the grouping of a block) is based on a predetermined value. For example, in implementations, the size of each native block, the scaled values of each native block, the scaling factors 120 of each native block, or any combination thereof are indicated to AU 112 (e.g., indicated to one or more instances of block-scaled dot-product circuitry 116) in one or more instructions, commands, draw calls, or any combination thereof received from one or more applications 108. That is to say, the size of each native block, the scaled values of each native block, the scaling factors 120 of each native block, or any combination thereof are stored as program code 110 and are sent to AU 112 as one or more instructions, commands, draw calls, or any combination thereof. For example, in implementations, an application 108 includes program code 110 blocking a matrix into one or more one-dimensional application blocks or one or more multi-dimensional application blocks. Such application blocks, for example, include two or more one-dimensional native blocks or multi-dimensional native blocks that are each associated with the same scaling factors 120. In implementations, regarding the predetermined size of the native blocks (e.g., number of matrix elements within the native blocks) into which the matrices to be multiplied are partitioned, a person of ordinary skill in the art will appreciate that as the size of the native blocks decrease, the amount of information lost in the native blocks decreases as fewer elements within the native blocks are scaled by the same scaling factor 120. Further, as the size of the native blocks decreases, the hardware resources needed to multiply the matrices increase due to each matrix having a greater number of native blocks to be multiplied. Similarly, as the size of the native blocks increases, the amount of information lost in the native blocks increases due to more elements within the native blocks being scaled by the same scaling factor 120. However, because more elements within the native blocks are scaled by the same scaling factor 120, the memory footprints of the native blocks decrease, the bandwidth needed to multiply the matrices decreases, and the number of scaling operations required to multiply the matrices decreases.

After each matrix to be multiplied is partitioned into one or more application blocks, native blocks (e.g., one-dimensional scaled blocks, multi-dimensional scaled blocks), or both, block-scaled dot-product circuitry 116 is configured to determine the dot products of the matrices by multiplying one or more native blocks of a first matrix by one or more native blocks of a second matrix. To this end, block-scaled dot-product circuitry 116 includes one or more block-scaled dot-product units 122 each including circuitry configured to determine a dot product of at least a portion of a native block of a first matrix and at least a portion of a corresponding native block of a second matrix. For example, a block-scaled dot-product unit 122 is configured to first multiply elements within a native block of a first matrix by corresponding elements in a native block of a second matrix to produce a set of products. The block-scaled dot-product unit 122 then determines a sum of the products in the set of products. This sum determined from the set of products, for example, represents a scaled dot product of at least a portion of the native block of the first matrix and at least a portion of the corresponding native block of the second matrix. According to some implementations, the block-scaled dot-product unit 122 is configured to produce the scaled dot product in a fixed-point format having a predetermined number of bits while in other implementations the block-scaled dot-product unit 122 is configured to produce the scaled dot product in a floating-point format. After determining the scaled dot product, the block-scaled dot-product unit 122 applies the scaling factor 120 associated with the native block of the first matrix and the scaling factor 120 associated with the native block of the second matrix to the dot product to produce an unscaled dot product. In implementations where a row or column, respectively, of each matrix is partitioned into two or more native blocks, a block-scaled dot-product unit 122 is configured to add the unscaled dot product to one or more other unscaled dot products determined by one or more other block-scaled dot-product units 122, provide the unscaled dot product to one or more other block-scaled dot-product units 122, or both so as to determine the unscaled dot produce of a first row of the first matrix and a first column of the second matrix.

As an example, in implementations, block-scaled dot-product circuitry 116 includes a first configuration of block-scaled dot-product units 122 together configured to determine the dot products of matrices partitioned into one-dimensional scaled blocks. Such a first configuration, for example, includes one or more rows of block-scaled dot-product units 122. Within the first configuration, each row includes one or more block-scaled dot-product units 122, and each row is configured to determine the dot product of a corresponding row of a first matrix and a corresponding column of a second matrix. For example, within each row of this first configuration, a first block-scaled dot-product unit 122 of the row determines an unscaled dot product of a first native block of a corresponding row of the first matrix and a first native block of a corresponding column of the second matrix and provides this unscaled dot product to a second block-scaled dot-product unit 122 in the row. The second block-scaled dot-product unit 122 of the row then determines an unscaled dot product of a second native block of the corresponding row of the first matrix and a second native block of the corresponding column of the second matrix and adds this unscaled dot product to the unscaled dot product provided from the first block-scaled dot-product unit 122 of the row to produce a partial dot product. The second block-scaled dot-product unit 122 then provides this partial dot product to a third block-scaled dot-product unit 122 in the row. The third block-scaled dot-product unit 122 then determines a dot product of a third native block of the corresponding row of the first matrix and a third native block of the corresponding column of the second matrix and adds this dot product to the partial dot product provided by the second block-scaled dot-product unit 122 to produce, for example, a second partial dot product.

Within the first configuration, the block-scaled dot-product units 122 of a row continue in this way until a last block-scaled dot-product unit 122 of the row receives a partial dot product. The last block-scaled dot-product unit 122 of the row is configured to determine a dot product of the final native block of the corresponding row of the first matrix and the final native block of the corresponding column of the second matrix. Such a last block-scaled dot-product unit 122 then adds the unscaled dot product of the final native block of the corresponding row of the first matrix and the final native block of the corresponding column of the second matrix to the partial dot product provided by a previous block-scaled dot-product unit 122 in the row to produce the final dot product of the corresponding row of the first matrix and the corresponding column of the second matrix. As such, within the first configuration, each row includes block-scaled dot-product units 122 arranged so as to provide a partial dot product to a subsequent block-scaled dot-product unit 122 until a final dot product has been determined for a corresponding row of the first matrix and the corresponding column of the second matrix.

Additionally, in implementations, block-scaled dot-product circuitry 116 includes a second configuration of block-scaled dot-product units 122 configured to determine the dot products of matrices partitioned into one or more multi-dimensional blocks (e.g., multi-dimensional scaled blocks). This second configuration, for example, includes a number of block-scaled dot-product units 122 arranged in a first direction (e.g., arranged in a number of rows) and arranged in a second direction (e.g., arranged in a number of columns). In implementations, the block-scaled dot-product units 122 of each row in the second configuration are connected similarly to the block-scaled dot-product units 122 in the first configuration. For example, a first block-scaled dot-product unit 122 of a row in the second configuration is configured to first determine a first partial scaled dot product by determining the scaled dot product of the elements in a first row of a first native block of a first matrix and elements in a first column of a first native block of a native block of a second matrix. After determining this first partial scaled dot product, the first block-scaled dot-product unit 122 of the row provides the first partial scaled dot product to a second block-scaled dot-product unit 122 in the row. Such a second block-scaled dot-product unit 122 in the row is configured to then determine the scaled dot product of the elements in the first row of a second native block of the first matrix and the elements in the first column of a second native block of the second matrix and add this determined scaled dot product to the first partial scaled dot product provided by the first block-scaled dot-product unit 122 in the row. In this way, each row of block-scaled dot-product units 122 in the second configuration is configured to determine a scaled dot product a corresponding row of the first matrix and a first column of the second matrix.

Further, within the second configuration, the block-scaled dot-product units 122 of each column are connected such that a first block-scaled dot-product unit 122 of a column is configured to determine a first partial scaled dot product by determining the scaled dot product of the elements in a first row of a corresponding native block of the first matrix and a first column of a corresponding native block of the second matrix. Further, a second block-scaled dot-product unit 122 in the column is configured to determine the scaled dot product of the elements in a second row of the first native block of the first matrix and the first column of the first native block of the second matrix. Likewise, a third block-scaled dot-product unit 122 in the column is configured to determine the scaled dot product of the elements in a third row of the first native block of the first matrix and the first column of the first native block of the second matrix. Due to the block-scaled dot-product units 122 being arranged in this way in each column, each column within the second configuration is configured to determine at least partial scaled dot products of at least a portion of each row in the first matrix and at least a portion of a corresponding column of the second matrix.

In this way, the second configuration of block-scaled dot-product circuitry 116 is configured to perform matrix multiplication for multi-dimensionally blocked matrices (e.g., matrices partitioned into multi-dimensional scaled blocks). Because the second configuration is configured to determine the dot product of two matrices that are multi-dimensionally blocked, the second configuration only requires a single partitioned version of the matrices to be generated even when matrices are used on both sides of the operand or when matrices are to be transposed. In this way, block-scaled dot-product circuitry 116 is able to perform matrix multiplication for applications 108 such as machine-learning applications, neural network applications, radar applications, and the like without having to generate multiple partitioned versions of the matrices, helping to reduce the memory footprint and hardware resources needed to perform matrix multiplication.

In implementations, block-scaled dot-product circuitry 116 is configured to switch between the first configuration and the second configuration. That is to say, each instance of block-scaled dot-product circuitry 116 is configured to switch between a first mode configured to handle matrices partitioned into one-dimensional scaled blocks and a second mode configured to handle matrices partitioned into multi-dimensional scaled blocks. To this end, each instance of block-scaled dot-product circuitry 116 includes or is otherwise connected to a respective scaling factor distribution circuitry 118-1, 118-2, 118-N. Such scaling factor distribution circuitry 118, for example, is configured to distribute scaling factors 120 to each block-scaled dot-product unit 122 within an instance of block-scaled dot-product circuitry 116 such that the block-scaled dot-product units 122 are arranged in the first configuration to handle one-dimensionally blocked matrices or in the second configuration to handle multi-dimensionally blocked matrices. According to implementations, scaling factor distribution circuitry 118 is configured to distribute scaling factors 120 based on one or more instructions received from an application 108. As an example, based on receiving one or more instructions indicating matrices partitioned into one-dimensional scaled blocks, scaling factor distribution circuitry 118 distributes scaling factors 120 such that the block-scaled dot-product units 122 are arranged in the first configuration to handle one-dimensionally blocked matrices. Further, based on receiving one or more instructions indicating matrices partitioned into multi-dimensional scaled blocks, scaling factor distribution circuitry 118 distributes scaling factors 120 such that the block-scaled dot-product units 122 are arranged in the second configuration to handle multi-dimensionally blocked matrices.

In implementations, the processing system 100 also includes a central processing unit (CPU) 102 that is connected to the bus 128 and therefore communicates with AU 112 and the memory 106 via the bus 128. The CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. The processor cores 104 execute instructions such as program code 110 for one or more applications 108 stored in the memory 106 and the CPU 102 stores information in the memory 106 such as the results of the executed instructions. According to implementations, an input/output (I/O) engine 124 includes hardware and software to handle input or output operations associated with the display 126, as well as other elements of the processing system 100 such as keyboards, mice, printers, external disks, and the like. The I/O engine 124 is coupled to the bus 128 so that the I/O engine 124 communicates with the memory 106, AU 112, or CPU 102.

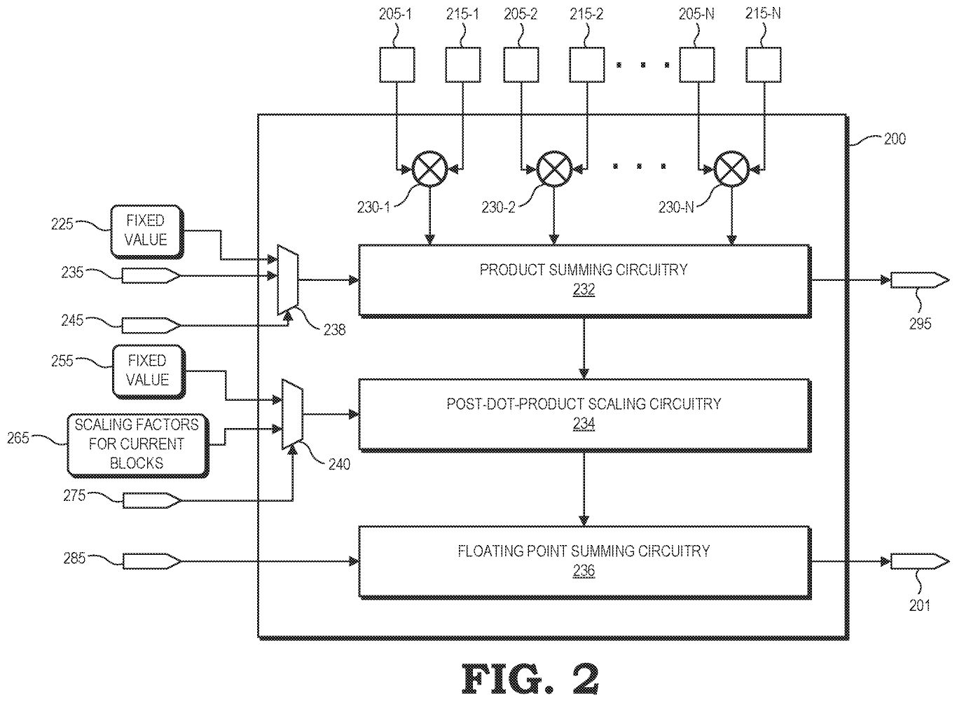

Referring now to FIG. 2, an example block-scaled dot-product unit 200 is presented. According to implementations, example block-scaled dot-product unit 200 is implemented in processing system 100 as one or more block-scaled dot-product units 122. In implementations, example block-scaled dot-product unit 200 is configured to determine a dot product of at least a portion of a first native block of a first matrix (e.g., a first native block of an application block of a first matrix) and at least a portion of a first native block of a second matrix (e.g., a first native block of an application block of the second matrix). Referring to the example implementation presented in FIG. 2, a first native block of a first matrix to be multiplied includes three elements 205-1, 205-2, 205-N (e.g., elements of the first matrix). Similarly, a first native block of a second matrix to be multiplied includes three elements 215-1, 215-2, 215-N (e.g., elements of the second matrix). Though the example implementation presented in FIG. 2 shows the native blocks of the matrices as each including three elements (205-1, 205-2, 205-N, 215-1, 215-2, 215-N, respectively) representing an N number of elements, in other implementations, each native block an include any number of elements. In implementations, the first native block of the first matrix and the first native block of the second matrix include the same number of elements.

To determine the dot product of at least a portion of the native block of the first matrix and at least a portion of the native block of the second matrix, example block-scaled dot-product unit 200 includes multipliers 230-1, 230-2, 230-N each configured to determine a product of an element 205 from the native block of the first matrix and a corresponding element 215 from the native block of the second matrix. For example, multiplier 230-1 is configured to determine the product of 205-1 and 215-1, multiplier 230-2 is configured to determine the product of 205-2 and 215-2, and multiplier 230-N is configured to determine the product of 205-N and 215-N. According to some implementations, example block-scaled dot-product unit 200 includes a number of multipliers equal to the number of matrix elements in a first direction of the native blocks of the matrices being multiplied (e.g., equal to the size of the native blocks). In implementations, each multiplier 230 is configured to provide a respective product of corresponding elements 205, 215 to product summing circuitry 232. Product summing circuitry 232, in implementations, is configured to add the products from each multiplier 230 so as to generate a scaled sum 295 (e.g., at least a scaled partial dot product of a first row of the first matrix and a first column of the second matrix). In some implementations, product summing circuitry 232 is configured to produce scaled sum 295 in a fixed-point format based on a predetermined precision while in other implementations, product summing circuitry 232 is configured to produce scaled sum 295 in a floating-point format. Further, according to some implementations, product summing circuitry 232 is configured to provide scaled sum 295 to the product summing circuitry 232 of a subsequent block-scaled dot-product unit 122 (e.g., a block-scaled dot-product unit 122 coming after example block-scaled dot-product unit 200 in a configuration of block-scaled dot-product circuitry 116).

After generating scaled sum 295, product summing circuitry 232 provides the scaled sum 295 to post-dot-product scaling circuitry 234 which is configured to apply one or more scaling factors 120 to the scaled sum 295. For example, post-dot-product scaling circuitry 234 multiplies scaled sum 295 by a first scaling factor 120 associated with the first native block of the first matrix and a second scaling factor 120 associated with the first native block of the second matrix. In the example implementation presented in FIG. 2, the first scaling factor 120 associated with the first native block of the first matrix and the second scaling factor 120 associated with the first native block of the second matrix are represented as scaling factors for current blocks 265. After applying the scaling factors for the current blocks 265 to the scaled sum 295, post-dot-product scaling circuitry 234 produces an unscaled sum that is provided to floating point summing circuitry 236. In implementations, post-dot-product scaling circuitry 234 is configured to add the unscaled sum provided from post-dot-product scaling circuitry 234 to one or more other unscaled sums 285 produced from one or more block-scaled dot-product units 122. For example, based on a row of the first matrix and a column of the second matrix being partitioned into two or more native blocks, a first block-scaled dot-product unit 122 is configured to produce a first unscaled sum 285 (e.g., partial dot product) representing the dot product of elements of a first native block in a first row of the first matrix and elements of a first native block in a first column of the second matrix. Such a first unscaled sum 285 is then provided to floating point summing circuitry 236 of example block-scaled dot-product unit 200. The floating point summing circuitry 236 adds the first unscaled sum 285 to the unscaled sum determined from elements 205-1, 205-2, 205-N of a native block of the first row of the first matrix and elements 215-1, 215-2, 215-N of a native block of the first column of the second matrix to produce a partial dot product 201. According to implementations, floating point summing circuitry 236 is configured to produce partial dot product 201 in a floating point format. Further, in some implementations, floating point summing circuitry 236 is configured to provide partial dot product 201 to a subsequent block-scaled dot-product unit 122 so as to determine the dot product of the first row of the first matrix and the first column of the second matrix.

According to some implementations, one or more applications 108 are configured to partition the matrices to be multiplied into one or more application blocks. These application blocks, for example, each include one or more native blocks that, in some implementations, share a scaling factor 120. That is to say, all the elements in an application block are associated with the same scaling factor 120. To help reduce the processing resources needed to determine a dot product for matrices partitioned into one or more application blocks, one or more instances of block-scaled dot-product circuitry 116 are configured to determine the scaled sum (e.g., scaled partial dot product) of the elements in a first application block of a first matrix and the elements in a first application block of the second matrix before applying a scaling factor 120. To this end, in some implementations, product summing circuitry 232 is configured to receive a bit 245 indicating whether the native blocks being multiplied by example block-scaled dot-product unit 200 share scaling factors 120 with native blocks multiplied by one or more other previous block-scaled dot-product units 122 (e.g., block-scaled dot-product units 122 coming before example block-scaled dot-product unit 200 in a configuration of block-scaled dot-product circuitry 116).

Based on bit 245 indicating the native blocks being multiplied by example block-scaled dot-product unit 200 share scaling factors 120 with native blocks multiplied by one or more other previous block-scaled dot-product units 122, product summing circuitry 232 adds the sum of the products provided by multipliers 230 to a previous scaled sum 235 provided from a previous block-scaled dot-product unit 122 (e.g., block-scaled dot-product unit 122 immediately preceding example block-scaled dot-product unit 200 in a configuration of block-scaled dot-product circuitry 116) to produce scaled sum 295. For example, in some implementations, product summing circuitry 232 is connected to a multiplexer 238 configured to select between a fixed value 225 (e.g., 0) and a previous scaled sum 235 provided from a previous block-scaled dot-product unit 122 based on bit 245. Based on bit 245 indicating that the native blocks being multiplied by example block-scaled dot-product unit 200 do not share scaling factors 120 with native blocks multiplied by one or more other previous block-scaled dot-product units 122 (e.g., bit 245 having a first value), multiplexer 238 provides fixed value 225 to product summing circuitry 232 such that, for example, 0 is added to the sum of the products from multipliers 230 to produce scaled sum 295. In implementations, fixed value 225 is in a floating point format or fixed point format. For example, according to some implementations, fixed value 225 is in the same format as the previous scaled sum 235. Further, based on bit 245 indicating that the native blocks being multiplied by example block-scaled dot-product unit 200 do share scaling factors 120 with native blocks multiplied by one or more other previous block-scaled dot-product units 122 (e.g., bit 245 having a second value), multiplexer 238 provides previous scaled sum 235 to product summing circuitry 232 such that, for example, the previous scaled sum 235 is added to the sum of the products from multipliers 230 to produce scaled sum 295. After producing scaled sum 295, product summing circuitry 232 then provides scaled sum 295 to post-dot-product scaling circuitry 234.

Additionally, in implementations, post-dot-product scaling circuitry 234 is configured to apply scaling factors for current blocks 265 to scaled sum 295 based on bit 275. Bit 275, for example, indicates whether scaling factors 120 are to be applied to scaled sum 295. According to implementations, bit 275 indicates that scaling factors 120 are to be applied to scaled sum 295 when example block-scaled dot-product unit 200 is configured to determine the dot product of the last native blocks in respective application blocks, when example block-scaled dot-product unit 200 is configured to determine the dot product of native blocks that do not share scaling factors 120 with one or more subsequent native blocks to be multiplied by one or more subsequent block-scaled dot-product units 122, or both. Based on bit 275 indicating that scaling factors 120 are to be applied to scaled sum 295, post-dot-product scaling circuitry 234 applies scaling factors for current blocks 265 to scaled sum 295 to produce an unscaled sum that is then provided to floating point summing circuitry 236. Further, Based on bit 275 indicating that scaling factors 120 are not to be applied to scaled sum 295, post-dot product scaling circuitry does not apply scaling factors for current blocks 265 to scaled sum 295 and then provides scaled sum 295 to floating point summing circuitry 236. As an example, in implementations, post-dot-product scaling circuitry 234 is connected to a multiplexer 240 configured to select between a fixed value 255 (e.g., 0) and scaling factors for current blocks 265 based on bit 275. In fixed value 255 is in a floating point format or fixed point format. For example, according to some embodiments, fixed value 255 is in the same format as fixed value 225, previous scaled sum 235, or both. Based on bit 275 indicating that scaling factors 120 are not to be applied to scaled sum 295, multiplexer 240 provides the fixed value 255 to post-dot-product scaling circuitry 234 such that no scaling factors 120 are applied to scaled sum 295. Further based on bit 275 indicating that scaling factors 120 are to be applied to scaled sum 295, multiplexer 240 provides scaling factors for current blocks 265 to post-dot-product scaling circuitry 234 such that scaling factors for current blocks 265 are applied to scaled sum 295 to produce an unscaled sum.

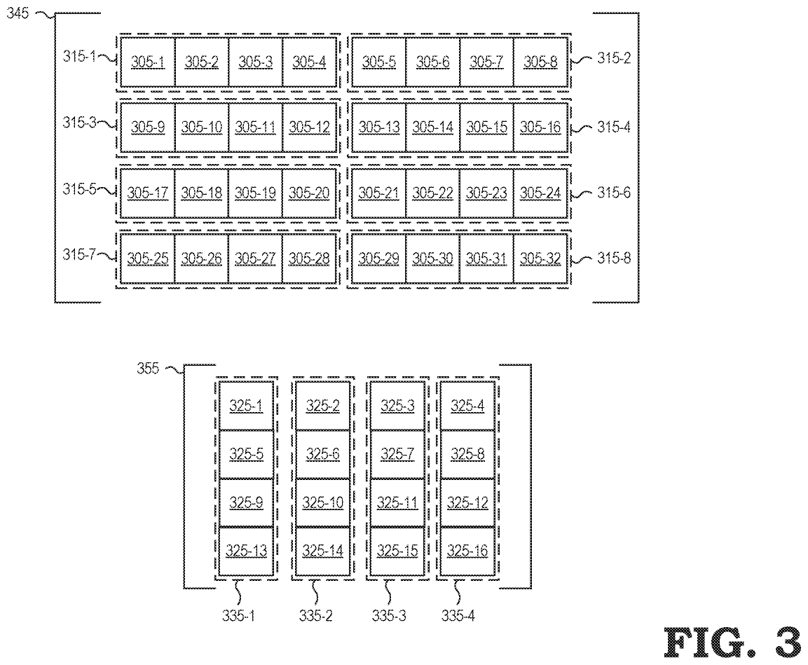

Referring now to FIG. 3, example matrices partitioned into one-dimensional scaled blocks are presented, in accordance with some implementations. According to implementations, a first example matrix 345 includes a first row having elements 305-1, 305-2, 305-3, 305-4, 305-5, 305-6, 305-7, and 305-8; a second row having elements 305-9, 305-10, 305-11, 305-12, 305-13, 305-14, 305-15, and 305-16; a third row having elements 305-17, 305-18, 305-19, 305-20, 305-21, 305-22, 305-23, and 305-24; and a fourth row having elements 305-25, 305-26, 305-27, 305-28, 305-29, 305-30, 305-31, and 305-32. In implementations, each row of first example matrix 345 is partitioned into one-dimensional native blocks 315 that each include four elements 305. That is to say, first example matrix 345 is partitioned into eight native blocks (315-1, 315-2, 315-3, 315-4, 315-5, 315-6, 315-7, 315-8) in a first direction. Further, FIG. 3 presents a second example matrix 355 that includes a first column having elements 325-1, 325-5, 325-9, 325-13; a second column having elements 325-2, 325-6, 325-10, 325-14; a third column having elements 325-3, 325-7, 325-11, 325-15; and a fourth column having elements 325-4, 325-8, 325-12, 325-16. In implementations, each column of second example matrix 355 is partitioned into one-dimensional native blocks 335 each including four elements 325. That is to say, first example matrix 345 is partitioned into four native blocks (335-1, 335-2, 335-3, 335-4) in a second direction that is perpendicular to the first direction of first example matrix 345. In some implementations, each matrix 345, 355 is partitioned into one or more one-dimensional application blocks that each include one or more one-dimensional native blocks 315, 335. As an example, according to some implementations, first example matrix 345 is partitioned into four application blocks in the first direction such that a first application block includes native blocks 315-1 and 315-2; a second application block includes native blocks 315-3 and 315-4; a third application block includes native blocks 315-5 and 315-6; and a fourth application block includes native blocks 315-7 and 315-8.

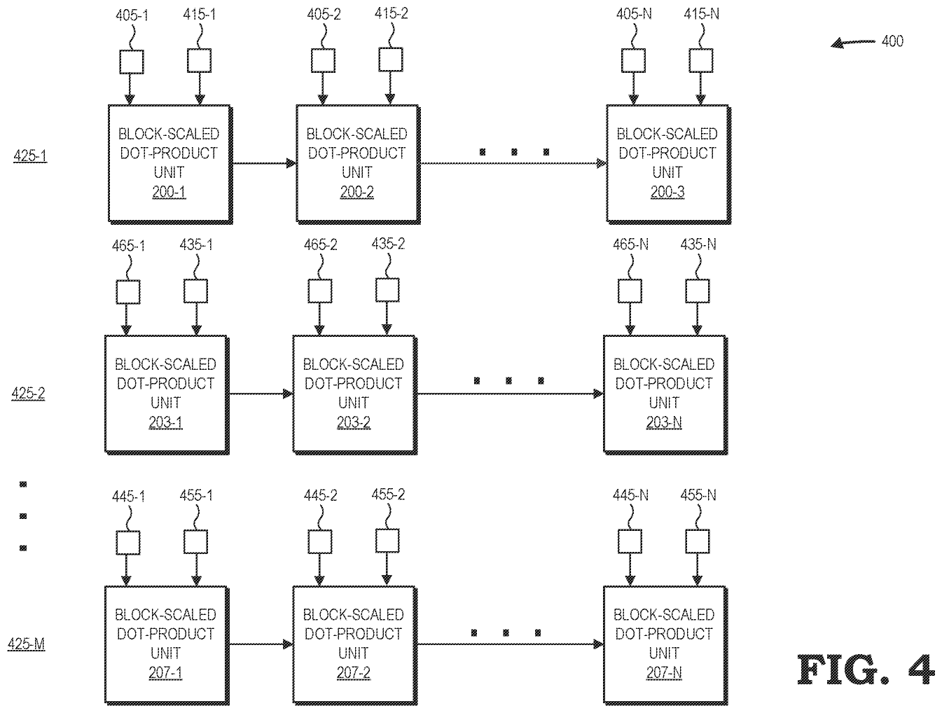

Referring now to FIG. 4, an example configuration 400 for block-scaled dot-product circuitry 116 to handle one-dimensional block-scaled matrix multiplication is presented, in accordance with some implementations. In implementations, example configuration 400 includes one or more rows 425 each including one or more block-scaled dot-product units 200, 203, and 207, respectively. According to embodiments, block-scaled dot-product units 203 and 207 are similar to or the same as block-scaled dot-product units 200. Referring to the example implementation presented in FIG. 4, example configuration 400 includes a first row 425-1 having block-scaled dot-product unit 200-1, block-scaled dot-product unit 200-2, and block-scaled dot-product unit 200-3; a second row 425-2 having block-scaled dot-product unit 203-1, block-scaled dot-product unit 203-2, and block-scaled dot-product unit 203-N; and a third row 425-L having block-scaled dot-product unit 207-1, block-scaled dot-product unit 207-2, and block-scaled dot-product unit 207-N. Though the example implementation in FIG. 4 presents example configuration 400 as including three rows 425-1, 425-2, 425-L representing an L number of rows, in other implementations, example configuration 400 can include any number of rows. Additionally, though the example implementation in FIG. 4 presents each row 425 as having three block-scaled dot-product units 200, 203, 207 each representing an N number of block-scaled dot-product units 200, 203, 207, respectively, in other implementations, each row 425 may have any number of block-scaled dot-product units. For example, in some implementations, each row 425 has a number of block-scaled dot-product units 200, 203, 207 equal to the number of native blocks in which a row of a matrix to be multiplied is partitioned, a column of a matrix to be multiplied is partitioned, or both.

According to implementations, example configuration 400 is configured to determine a dot product of a first matrix one-dimensionally blocked in a first direction (e.g., partitioned into one-dimensional native blocks in a first direction) and a second matrix one-dimensionally blocked in a second direction (e.g., partitioned into one-dimensional native blocks in a second direction). To this end, each row 425 of example configuration 400 is configured to determine the dot product of a corresponding row of the first matrix and a corresponding column of the second matrix.

For example, in implementations, a first matrix to be multiplied by example configuration 400 includes a first row partitioned into native blocks 405-1, 405-2, and 405-N; a second row partitioned into native blocks 465-1, 465-2, and 465-N; and a third row partitioned into native blocks 445-5, 445-6, and 445-N. Additionally, a second matrix to be multiplied by example configuration 400 includes a first column partitioned into native blocks 415-1, 415-2, and 415-N; a second column partitioned into native blocks 435-1, 435-2, and 435-N; and a third column partitioned into native blocks 455-1, 455-2, and 455-N. Within each row of example configuration 400, each block-scaled dot-product unit 200 is configured to determine the dot product of a respective native block 405 forming part of a corresponding row of the first matrix and a respective native block 415 forming a corresponding column of the second matrix. After determining such a dot product, each block-scaled dot-product unit 200 is configured to then add this dot product to a partial dot product (e.g., partial dot product 201) provided from another block-scaled dot-product unit in the row 425 (e.g., a previous block-scaled do-product unit 200), provide a partial dot product (e.g., partial dot product 201) to another block-scaled dot-product unit in the row 425 (e.g., a subsequent block-scaled do-product unit 200), or both. As an example, referring to the implementation presented in FIG. 4, a first block-scaled dot-product unit 200-1 of a first row 425-1 is configured to determine a dot product of a first native block 405-1 forming a portion of a first row of the first matrix and a second native block 415-1 forming a portion of a first column of the second matrix. After determining this dot product, the first block-scaled dot-product unit 200-1 provides the dot product as a partial dot product to a second block-scaled dot-product unit 200-2 of the first row 425-1. The second block-scaled dot-product unit 200-2 then determines a dot product of a second native block 405-2 forming a portion of the first row of the first matrix and a second native block 415-2 forming a portion of the first column of the second matrix and adds this dot product to the partial dot product provided by the first block-scaled dot-product unit 200-1 to produce a second partial dot product. The second block-scaled dot-product unit 200-2 then provides this second partial dot product to a third block-scaled dot-product unit 200-3 of the row 425-1. In this way, each row 425 of example configuration 400 is configured to determine the dot product of a corresponding row of a first matrix and a corresponding column of a second matrix.

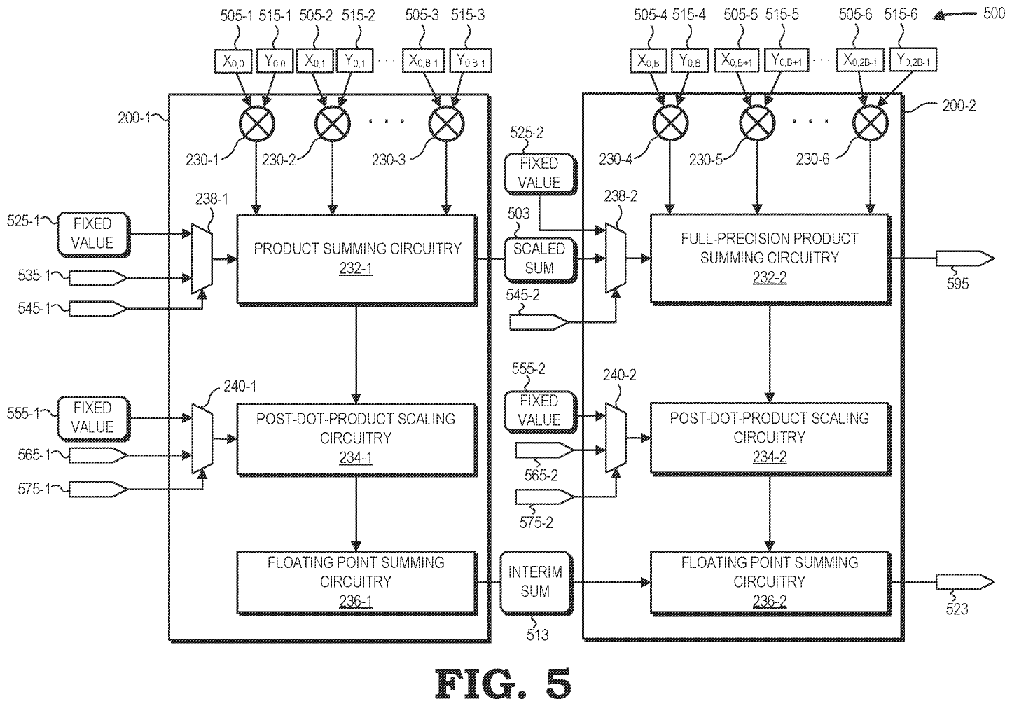

Referring now to FIG. 5, an example row 500 of a first configuration for block-scaled dot-product circuitry 116 is presented, in accordance with some implementations. According to implementations, example row 500 is implemented as one or more rows 425 in example configuration 400. According to implementations, example row 500 includes a first block-scaled dot-product unit 200-1 configured to determine a dot product of a first native block of a first row of a first matrix and a first native block of a first column of a second matrix. To this end, the first block-scaled dot-product unit 200-1 includes multipliers 230-1, 230-2, 230-N each configured to multiply a first element 505-1 (e.g., X_{0,0}), a second element 505-2 (e.g., X_{0,1}), and a third element 505-3 (X_{0,B-1}) from the first native block (e.g., native block 405-1) of a first row of a first matrix by a first element 515-1 (e.g., Y_{0,0}), a second element 515-2 (e.g., Y_{0,1}), and a third element 515-3 (Y_{0,B-1}), respectively, from the first native block (e.g., native block 415-1) of a first column of the second matrix. Though the example embodiment presented in FIG. 5, shows each native block being multiplied by the first block-scaled dot-product unit 200-1 as each including three elements (505-1, 505-2, 505-3, 515-1, 515-2, 515-3), respectively, representing a B number of elements, in other embodiments the native blocks can each include any number of elements.

According to implementations, each multiplier 230 provides the respective product produced from multiplying a respective element 505 by a corresponding element 515 to product summing circuitry 232-1. Product summing circuitry 232-1 is configured to add the products from the multipliers 230 together to produce a scaled sum 503 and provide scaled sum 503 to post-dot-product scaling circuitry 234-1. Post-dot-product scaling circuitry 234-1 is configured to then apply one or more scaling factors 120 to the scaled sum 503. For example, post-dot-product scaling circuitry 234-1 multiplies scaled sum 503 by a first scaling factor 120 associated with the first native block of the first matrix and a second scaling factor 120 associated with the first native block of the second matrix. Such scaling factors 120 associated with the first native block of the first matrix and the second native block of the second matrix are presented in FIG. 4 as scaling factors for current blocks 565-1. After applying scaling factors for current blocks 565-1 to the scaled sum 503, post-dot-product scaling circuitry 234-1 produces an unscaled sum that is provided to floating point summing circuitry 236-1. Floating point summing circuitry 236-1 then produces a floating point representation of the unscaled sum, represented in FIG. 5 as interim sum 513, and provides interim sum 513 to floating point summing circuitry 236-2 of the second block-scaled dot-product unit 200-2.

Further, in implementations, example row 500 includes a second block-scaled dot-product unit 200-2 configured to determine a dot product of a second native block of the first row of the first matrix and a second native block of the first column of the second matrix. As an example, the second block-scaled dot-product unit 200-2 includes multipliers 230-4, 230-5, 230-6 each configured a first element 505-4 (e.g., X_{0,B}), a second element 505-5 (e.g., X_{0,B+1}), and a third element 505-6 (X_{0,2B-1}) from the second native block (e.g., native block 405-2) of a first row of a first matrix by a first element 515-4 (e.g., Y_{0,B}), a second element 515-5 (e.g., Y_{0,B+1}), and a third element 515-6 (Y_{0,2B-1}), respectively, from the second native block (e.g., native block 415-2) of a first column of the second matrix. Though the example embodiment presented in FIG. 5, shows each native block being multiplied by the second block-scaled dot-product unit 200-2 as each including three elements (505-4, 505-5, 505-6, 515-4, 515-5, 515-6), respectively, representing a B number of elements, in other embodiments the native blocks can each include any number of elements.

After multiplying corresponding elements 505, 515, each multiplier 230 then provides the respective product produced from multiplying the corresponding elements 505, 515 to product summing circuitry 232-2. Product summing circuitry 232-2 is configured to add the products from the multipliers 230 together to produce a second scaled sum 595 and provide the second scaled sum 595 to post-dot-product scaling circuitry 234-2. Post-dot-product scaling circuitry 234-2 is configured to multiply the second scaled sum 595 by a third scaling factor 120 associated with the second native block of the first matrix and a fourth scaling factor 120 associated with the second native block of the second matrix. Such scaling factors 120 associated with the second native block of the first matrix and the second native block of the second matrix are presented in FIG. 5 as scaling factors for current blocks 565-2. After applying scaling factors for current blocks 565-2 to the second scaled sum 595, post-dot-product scaling circuitry 234-3 produces a second unscaled sum that is provided to floating point summing circuitry 236-2. Floating point summing circuitry 236-2 then adds the second unscaled sum to the interim sum 513 provided by the first block-scaled dot-product unit 200-1 to produce partial dot product 523 in a floating point-format.

According to implementations, within example row 500, the first block-scaled dot-product unit 200-1 is configured to apply scaling factors to scaled sum 503 based on whether the native blocks being multiplied by the first block-scaled dot-product unit 200-1 shared scaling factors 120 with other native blocks being multiplied by other block-scaled dot-product units 200 in the example row 500. For example, in implementations, the first block-scaled dot-product unit 200-1 includes a multiplexer 238-1 configured to select between a fixed value 525-1 (e.g., 0) and a previous scaled sum 535-1 generated by a previous block-scaled dot-product unit 200 in the example row 500 based on bit 545-1. Bit 545-1, for example, indicates whether the native blocks being multiplied by the first block-scaled dot-product unit 200 share scaling factors 120 with native blocks multiplied by one or more other previous block-scaled dot-product units 200 in the example row 500. Based on bit 545-1 indicating that the native blocks being multiplied by the first block-scaled dot-product unit 200-1 do not share scaling factors 120 with native blocks multiplied by one or more other previous block-scaled dot-product units 200 in example row 500, multiplexer 238-1 provides fixed value 525-1 (e.g. fixed value 255) to product summing circuitry 232 such that, for example, 0 is added to the sum of the products from multipliers 230-1, 230-2, 230-N to produce scaled sum 503. Further, based on bit 545-1 indicating that the native blocks being multiplied by the first block-scaled dot-product unit 200-1 do share scaling factors 120 with native blocks multiplied by one or more other previous block-scaled dot-product units 200 in the example row 500, multiplexer 238-1 provides previous scaled sum 535-1 to product summing circuitry 232-1 such that, for example, the previous scaled sum 535-1 is added to the sum of the products from multipliers 230-1, 230-2, 230-N to produce scaled sum 503.

Additionally, the first block-scaled dot-product unit 200-1 includes a multiplexer 240-1 configured to select between a fixed value 555-1 (e.g., 0) and scaling factors for current blocks 565-1 based on bit 575-1. Bit 575-1, for example, indicates whether scaling factors 120 are to be applied to scaled sum 503. According to implementations, bit 575-1 indicates that scaling factors 120 are to be applied to scaled sum 503 when the first block-scaled dot-product unit 200-1 is configured to determine the dot product of the last native blocks in respective application blocks, when the last block-scaled dot-product unit 200-1 is configured to determine the dot product of native blocks that do not share scaling factors 120 with one or more subsequent native blocks to be multiplied by one or more subsequent block-scaled dot-product units 200 in the example row 500, or both. Based on bit 575-1 indicating that scaling factors 120 are not to be applied to scaled sum 503, multiplexer 240-1 provides the fixed value 555-1 to post-dot-product scaling circuitry 234-1 such that no scaling factors 120 are applied to scaled sum 503. Further based on bit 575-1 indicating that scaling factors 120 are to be applied to scaled sum 503, multiplexer 240-1 provides scaling factors for current blocks 565-1 to post-dot-product scaling circuitry 234-1 such that scaling factors for current blocks 565-1 are applied to scaled sum 503 to produce an unscaled sum provided to floating point summing circuitry 236-1.

Likewise, within example row 500, in implementations, the second block-scaled dot-product unit 200-2 is configured to apply scaling factors to the second scaled sum 595 based on whether the native blocks being multiplied by the second block-scaled dot-product unit 200-2 share scaling factors 120 with other native blocks being multiplied by other block-scaled dot-product units 200 in the example row 500. As an example, in some implementations, the second block-scaled dot-product unit 200-2 includes a multiplexer 238-2 configured to select between a fixed value 525-2 (e.g., 0) and scaled sum 503 provided by the first scaled-block dot product unit 200-1 based on bit 545-2. Bit 545-2, for example, indicates whether the native blocks being multiplied by the second block-scaled dot-product unit 200 share scaling factors 120 with native blocks multiplied by one or more other previous block-scaled dot-product units 200 in the example row 500 (e.g., the first block-scaled dot-product unit 200-1). Based on bit 545-2 indicating that the native blocks being multiplied by the second block-scaled dot-product unit 200-2 do not share scaling factors 120 with native blocks multiplied by one or more other previous block-scaled dot-product units 200 in example row 500, multiplexer 238-2 provides fixed value 525-2 to product summing circuitry 232-2 such that, for example, 0 is added to the sum of the products from multipliers 230-3, 230-4, 230-M to produce the second scaled sum 595. Additionally, based on bit 545-2 indicating that the native blocks being multiplied by the second block-scaled dot-product unit 200-2 do share scaling factors 120 with native blocks multiplied by one or more other previous block-scaled dot-product units 200 in the example row 500, multiplexer 238-2 provides scaled sum 503 to product summing circuitry 232-2 such that, for example, scaled sum 503 is added to the sum of the products from multipliers 230-3, 230-4, 230-M to produce a second scaled sum 595.

Further, the second block-scaled dot-product unit 200-2 includes a multiplexer 240-2 configured to select between a fixed value 555-2 (e.g., 0) and scaling factors for current blocks 565-2 based on bit 575-2. Bit 575-2 indicates, as an example, whether scaling factors 120 are to be applied to the second scaled sum 595. In implementations, bit 575-2 indicates that scaling factors 120 are to be applied to the second scaled sum 595 when the second block-scaled dot-product unit 200-2 is configured to determine the dot product of the last native blocks in respective application blocks, when the second block-scaled dot-product unit 200-2 is configured to determine the dot product of native blocks that do not share scaling factors 120 with one or more subsequent native blocks to be multiplied by one or more subsequent block-scaled dot-product units 200 in the example row 500, or both. Based on bit 575-2 indicating that scaling factors 120 are not to be applied to the second scaled sum 595, multiplexer 240-2 provides the fixed value 555-2 to post-dot-product scaling circuitry 234-2 such that no scaling factors 120 are applied to the second scaled sum 595. Additionally, based on bit 575-2 indicating that scaling factors 120 are to be applied to the second scaled sum 595, multiplexer 240-2 provides scaling factors for current blocks 565-2 to post-dot-product scaling circuitry 234-2 such that scaling factors for current blocks 565-2 are applied to the second scaled sum 595 to produce a second unscaled sum provided to floating point summing circuitry 236-2.

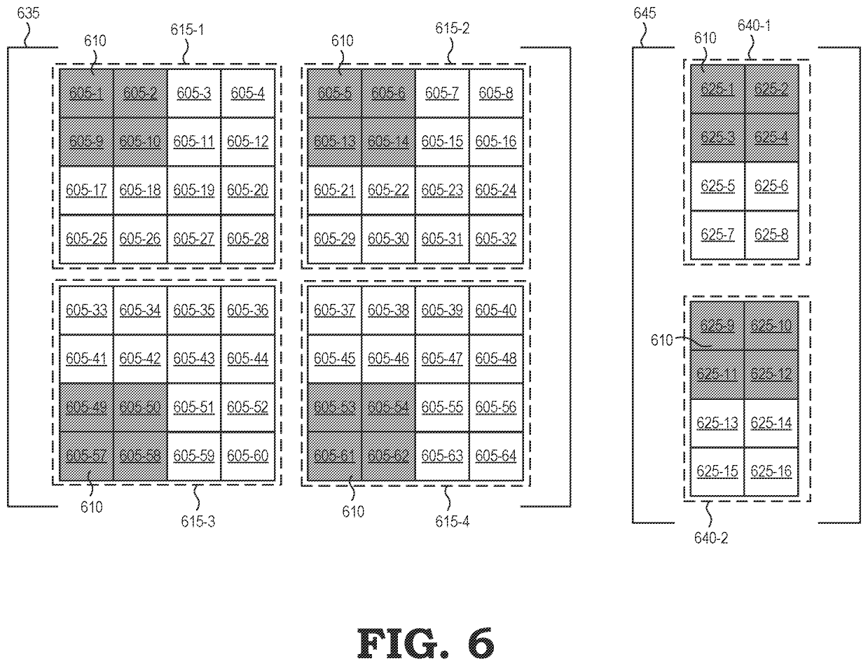

Referring now to FIG. 6, example matrices partitioned into multi-dimensional scaled blocks are presented, in accordance with some implementations. According to implementations, a first example matrix 635 includes elements 605 arranged in eight rows and eight columns. Additionally, the elements 605 of the first example matrix 635 are partitioned into multi-dimensional application blocks 615. Each multi-dimensional application block 615, for example, is defined by program code 110 for an application 108. That is to say, the size of and elements 605 of the first example matrix 635 in each multi-dimensional application block 615 is defined by one or more applications 108. Referring to the example implementation presented in FIG. 6, the first example matrix 635 includes a first application block 615-1 having elements 605-1, 605-2, 605-3, 605-4, 605-9, 605-10, 605-11, 605-12, 605-17, 605-18, 605-19, 605-20, 605-25, 605-26, 605-27, and 605-28; a second application block 615-2 having elements 605-5, 605-6, 605-7, 605-8, 605-13, 605-14, 605-15, 605-16, 605-21, 605-22, 605-23, 605-24, 605-29, 605-30, 605-31, and 605-32; a third application block 615-3 having element 605-33, 605-34, 605-35, 605-36, 605-41, 605-42, 605-43, 605-44, 605-49, 605-50, 605-51, 605-52, 605-57, 605-58, 605-59, and 605-60; and a fourth application block 615-4 having elements 605-37, 605-38, 605-39, 605-40, 605-45, 605-46, 605-47, 605-48, 605-53, 605-54, 605-55, 605-56, 605-61, 605-62, 605-63, and 605-64. According to implementations, each application block 615 includes two or more native blocks 610. In the implementation presented in FIG. 6, for example, each application block 615 includes four native blocks 610 that each have four elements 605 of the first example matrix 635. As an example, a native block 610 of the first application block 615-1 includes elements 605-1, 605-2, 605-3, and 605-4. In some implementations, each native block 610 within an application block 615 is associated with the same scaling factor 120.

Further, FIG. 6 presents a second example matrix 645 that includes elements 625 arranged in eight rows and two columns. The elements 625 of the second example matrix 645 are also partitioned into multi-dimensional application blocks 640. Each multi-dimensional application block 640, for example, is defined by program code 110 for an application 108. Referring to the example implementation presented in FIG. 6, the second example matrix 645 includes a first application block 640-1 having elements 625-1, 625-2, 625-3, 625-4, 625-5, 625-6, 625-7, and 625-8 and a second application block 640-2 having elements 625-9, 625-10, 625-11, 625-12, 625-13, 625-14, 625-15, and 625-16. In implementations, each application block 640 includes two or more native blocks 610. For example, in the implementation presented in FIG. 6, each application block 640 includes two native blocks 610 that each have four elements 625 of the example second matrix 645. As an example, a native block 610 of the first application block 640-1 includes elements 625-1, 625-2, 625-3, and 625-4. According to implementations, each native block 610 within an application block 640 is associated with the same scaling factor 120.

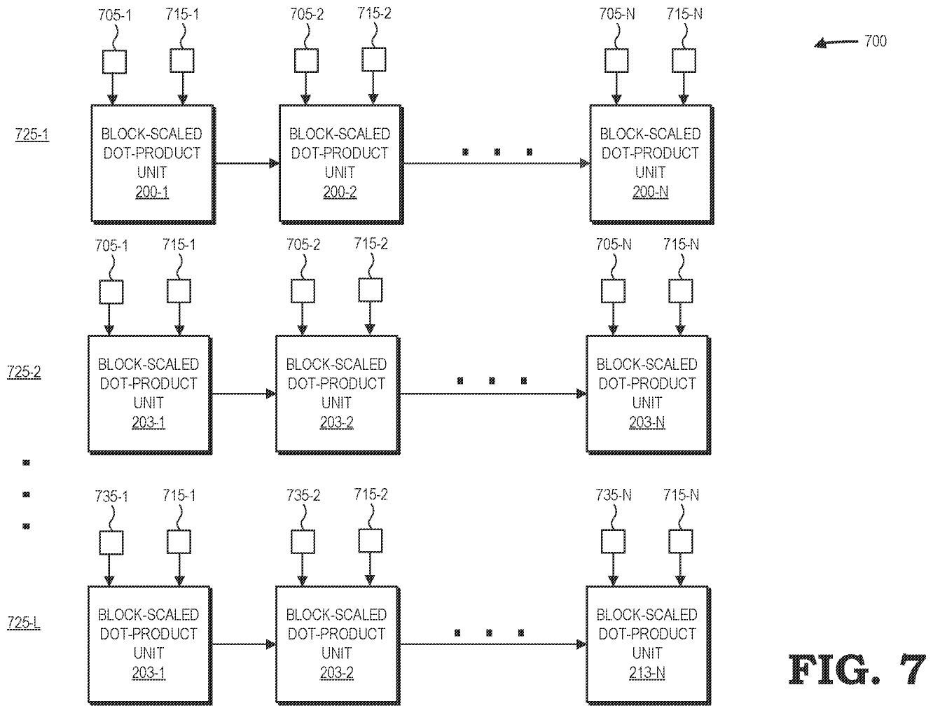

Referring now to FIG. 7, an example configuration 700 for block-scaled dot-product circuitry 116 to handle multi-dimensional block-scaled matrix multiplication is presented, in accordance with some implementations. According to implementations, example configuration 700 includes one or more rows 725 each including one or more block-scaled dot-product units 200. Referring to the example implementation presented in FIG. 7, example configuration 700 includes a first row 725-1 having block-scaled dot-product unit 200-1, block-scaled dot-product unit 200-2, and block-scaled dot-product unit 200-N; a second row 725-2 having block-scaled dot-product unit 203-1, block-scaled dot-product unit 203-2, and block-scaled dot-product unit 203-N; and a third row 725-L having block-scaled dot-product unit 207-1, block-scaled dot-product unit 207-2, and block-scaled dot-product unit 207-N. Though the example implementation in FIG. 7 presents example configuration 700 as including three rows 725-1, 725-2, 725-L representing an L number of rows, in other implementations, example configuration 700 can include any number of rows. Additionally, though the example implementation in FIG. 7 presents each row 725 as having three block-scaled dot-product units 200, 203, 207, respectively, representing an N number of block-scaled dot-product units 200, 203, 207, in other implementations, each row 725 may have any number of block-scaled dot-product units. For example, in some implementations, each row 725 has a number of block-scaled dot-product units 200, 203, 207 equal to the number of native blocks in which a row of a matrix to be multiplied is partitioned, a column of a matrix to be multiplied is partitioned, or both.

According to implementations, example configuration 700 is configured to determine a dot product of a first multi-dimensionally blocked matrix (e.g., a matrix partitioned into multi-dimensional scaled blocks) and a second multi-dimensionally blocked matrix. To this end, each row 725 of example configuration 700 is configured to determine the dot product of a corresponding row of the first matrix and a first column of the second matrix. As an example, in implementations, a first matrix to be multiplied by example configuration 700 is partitioned into multi-dimensional native blocks 705-1, 705-2, 705-N, 735-1, 735-2, 735-N. According to embodiments, each row of the first matrix is partitioned into a number of multi-dimensional native blocks, represented in the example embodiment of FIG. 7 as N. For example, multi-dimensional native blocks 705-1, 705-2, 705-N each include elements from at least a portion of a first row of the first matrix and a second row of the first matrix. Additionally, multi-dimensional native blocks 715-1, 715-2, 715-N, for example, each include elements from at least a portion of a third row of the first matrix. Likewise, a second matrix to be multiplied by example configuration 700 is partitioned into three native blocks 715-1, 715-2, 715-N. In implementations, each column of the second matrix is partitioned into a number of multi-dimensional native blocks, also represented in the example embodiment of FIG. 7 as N. For example, multi-dimensional native blocks 715-1, 715-2, 715-N each include elements from at least a portion of a first column of the second matrix.

Within each row 725, each block-scaled dot-product unit 200 is configured to determine the dot product of elements from a respective native block 705, 735 forming part of a corresponding row of the first matrix and elements from a respective native block 715 forming a part of the first column of the second matrix. After determining such a dot product, each block-scaled dot-product unit 200 is configured to then add this dot product to a partial dot product (e.g., partial dot product 201) provided from another block-scaled dot-product unit in the row 725 (e.g., a previous block-scaled dot-product unit 200), provide a partial dot product (e.g., partial dot product 201) to another block-scaled dot-product unit in the row 725 (e.g., a subsequent block-scaled do-product unit 200), or both. As an example, referring to the implementation presented in FIG. 7, a first block-scaled dot-product unit 203-1 of a second row 725-2 is configured to determine a dot product of elements from a first native block 705-1 forming a portion of a second row of the first matrix and elements from a second native block 715-1 forming a portion of the first column of the second matrix. After determining this dot product, the first block-scaled dot-product unit 203-1 of the row 725-2 provides the dot product as a partial dot product to a second block-scaled dot-product unit 203-2 of the row 725-2. This second block-scaled dot-product unit 203-2 then determines a dot product of elements from a second native block 705-2 forming another portion of the second row of the first matrix and elements from a second native block 715-2 forming another portion of the first column of the second matrix and adds this dot product to the partial dot product provided by the first block-scaled dot-product unit 203-1 to produce a second partial dot product. The second block-scaled dot-product unit 203-2 then provides this second partial dot product to a third block-scaled dot-product unit 203-N of the row 725-2. In this way, each row 725 of example configuration 700 is configured to determine the dot product of a corresponding row of a first matrix and a first column of a second matrix.

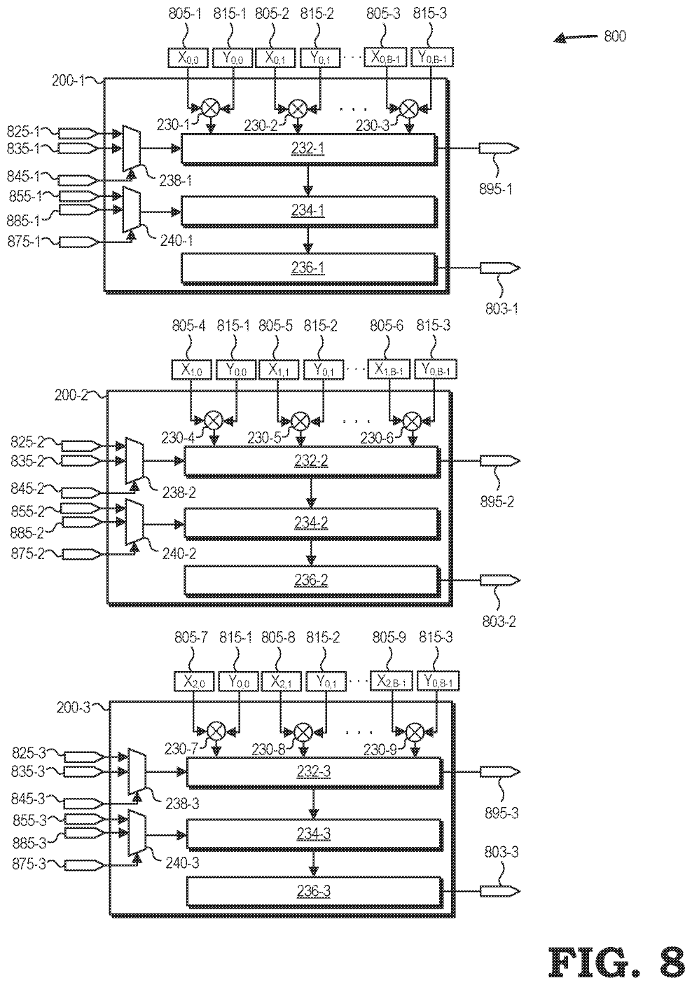

Referring now to FIG. 8, an example column 800 of a second configuration for block-scaled dot-product circuitry 116 is presented, in accordance with some implementations. According to implementations, example column 800 is implemented within example configuration 700. In implementations, example column 800 includes a first block-scaled dot-product unit 200-1 configured to determine a dot product of at least a portion of a first row of a first matrix and at least a portion of a first column of a second matrix. To this end, the first block-scaled dot-product unit 200-1 is configured to multiply a first element 805-1 (e.g., X_{0,0}), second element 805-2 (e.g., X_{0,1}), and third element 805-5 (e.g., X_{0,B-1}) of a first multi-dimensional native block (e.g., multi-dimensional native block 705-1) of a first matrix representing at least a portion of a first row of the first matrix by a first element 815-1 (e.g., Y_{0,0}), a second element 815-2 (e.g., Y_{0,1}), and a third element 815-3 (Y_{0,B-1}), respectively, from a first multi-dimensional native block (e.g., native block 715-1) of the second matrix representing at least a portion of a first column of the second matrix. Though the example embodiment presented in FIG. 8, shows a first multi-dimensional block of the first matrix including three elements (805-1, 805-2, 805-3), representing a B number of elements, from a first row of the first matrix and a first multi-dimensional block of the second matrix including three elements (815-1, 815-2, 815-3), representing a B number of elements, from a first column of the second matrix, in other embodiments, the multi-dimensional native blocks can each include any number of elements from the first row of the first matrix and the first column of the second matrix, respectively.

In embodiments, the first block-scaled dot-product unit 200-1 includes multipliers 230-1, 230-2, 230-3 each configured to multiply respective elements (805-1, 805-2, 805-5) from a first multi-dimensional scaled block of the first matrix representing at least a portion of the first row of the first matrix by corresponding elements (815-1, 815-2, 815-3) from a first multi-dimensional scaled block of the second matrix representing at least a portion of the first column of the second matrix. Each multiplier 230 then provides the product produced from multiplying a respective element 805 by a corresponding element 815 to product summing circuitry 232-1. Product summing circuitry 232-1 is configured to add the products from the multipliers 230 together to produce a scaled sum 895-1 and provide scaled sum 895-1 to post-dot-product scaling circuitry 234-1. Post-dot-product scaling circuitry 234-1 then applies one or more scaling factors 120 to the scaled sum 895-1. For example, post-dot-product scaling circuitry 234-1 multiplies scaled sum 895-1 by a first scaling factor 120 associated with the first native block of the first matrix and a second scaling factor 120 associated with the first native block of the second matrix. Such scaling factors 120 associated with the first native block of the first matrix and the second native block of the second matrix are presented in FIG. 4 as scaling factors for current blocks 865-1. After applying scaling factors for current blocks 865-1 to the scaled sum 895, post-dot-product scaling circuitry 234-1 produces an unscaled sum that is provided to floating point summing circuitry 236-1. Floating point summing circuitry 236-1 then produces a floating point representation of the unscaled sum, represented in FIG. 8 as partial dot product 803-1.

Additionally, example column 800 includes a second block-scaled dot-product unit 200-2 configured to determine a dot product of at least a portion of a second row of a first matrix and at least a portion of a first column of a second matrix. As an example, the second block-scaled dot-product unit 200-2 is configured to multiply a fourth element 805-4 (e.g., X_{1,0}), fifth element 805-2 (e.g., X_{1,1}), and sixth element 805-5 (e.g., X_{1,B-1}) of a first multi-dimensional native block (e.g., multi-dimensional native block 705-1) of a first matrix representing at least a portion of a second row of the first matrix by the first element 815-1 (e.g., Y_{0,0}), the second element 815-2 (e.g., Y_{0,1}), and the third element 815-3 (Y_{0,B-1}), respectively, from the first multi-dimensional native block (e.g., native block 715-1) of the second matrix representing at least a portion of the first column of the second matrix. According to implementations, the second block-scaled dot-product unit 200-2 includes multipliers 230-4, 230-5, 230-6 each configured to multiply respective elements (805-4, 805-5, 805-6) from the first multi-dimensional native block of the first matrix by corresponding elements (815-1, 815-2, 815-N) from the first multi-dimensional native block of the second matrix. Each multiplier 230 then provides the product produced from multiplying a respective element 805 by a corresponding element 815 to product summing circuitry 232-2 which produces a scaled sum 895-2. Product summing circuitry 232-2 provides scaled sum 895-2 to post-dot-product scaling circuitry 234-2 which, in turn, applies one or more scaling factors 120 to the scaled sum 895-2. Such scaling factors 120 applied to the second sum 895-2 are presented in FIG. 8 as scaling factors for current blocks 865-2. After applying scaling factors for current blocks 865-2 to the scaled sum 895-2, post-dot-product scaling circuitry 234-2 produces an unscaled sum that is provided to floating point summing circuitry 236-2 which then produces a floating point representation of the unscaled sum, represented in FIG. 8 as partial dot product 803-2.

In implementations, example column 800 also includes a third block-scaled dot-product unit 200-3 configured to determine a dot product of at least a portion of a third row of a first matrix and at least a portion of a first column of a second matrix. For example, the third block-scaled dot-product unit 200-3 is configured to multiply a seventh element 805-7 (e.g., X_{2,0}), eighth element 805-8 (e.g., X_{2,1}), and ninth element 805-9 (e.g., X_{2,B-1}) of, for example, a second multi-dimensional native block (e.g., multi-dimensional native block 735-1) of a first matrix representing at least a portion of a third row of the first matrix by the first element 815-1 (e.g., Y_{0,0}), the second element 815-2 (e.g., Y_{0,1}), and the third element 815-3 (Y_{0,B-1}), respectively, from the first multi-dimensional native block (e.g., native block 715-1) of the second matrix representing at least a portion of the first column of the second matrix. In implementations, the third block-scaled dot-product unit 200-3 includes multipliers 230-7, 230-8, 230-9 each configured to multiply respective elements (805-7, 805-8, 805-9) from the second multi-dimensional native block of the first matrix by corresponding elements (815-1, 815-2, 815-N) from the first multi-dimensional native block of the second matrix. Each multiplier 230 then provides the product produced from multiplying a respective element 805 by a corresponding element 815 to product summing circuitry 232-K which produces a scaled sum 895-K. Product summing circuitry 232-K also provides scaled sum 895-K to post-dot-product scaling circuitry 234-K which is configured to apply one or more scaling factors 120 to the scaled sum 895-K. The scaling factors 120 applied to the scaled sum 895-K are presented in FIG. 8 as scaling factors for current blocks 865-K. After applying scaling factors for current blocks 865-K to the scaled sum 895-K, post-dot-product scaling circuitry 234-K produces an unscaled sum that is provided to floating point summing circuitry 236-K, which, in turn, produces a floating point representation of the unscaled sum, represented in FIG. 8 as partial dot product 803-K.

According to implementations, within example column 800, the first block-scaled dot-product unit 200-1, the second block-scaled dot-product unit 200-2, and the third block-scaled dot-product unit 200-K are each configured to apply scaling factors to respective scaled sums 895-1, 895-2, 895-K based on whether the native blocks being multiplied by the block-scaled dot-product unit 200 share scaling factors 120 with other native blocks being multiplied by other block-scaled dot-product units 200 in a same row (e.g., rows 725). As an example, in implementations, each block-scaled dot-product unit 200 includes a respective multiplexer 238-1, 238-2, 238-3 configured to select between a fixed value 825-1, 825-2, 825-3 (e.g., fixed value 255), respectively, and a previous scaled sum 835-1, 835-2, 835, respectively based on corresponding bit 845-1, 845-2, 845-33. A bit 845, for example, indicates whether the native blocks being multiplied by a corresponding block-scaled dot-product unit 200 share scaling factors 120 with native blocks multiplied by one or more other previous block-scaled dot-product units 200 in the same row 725. Based on a bit 845 indicating that the native blocks being multiplied by the corresponding block-scaled dot-product unit 200 do not share scaling factors 120 with native blocks multiplied by one or more other previous block-scaled dot-product units 200 in the same row 725, an associated multiplexer 238 provides a respective fixed value 825 to the product summing circuitry 232 of the corresponding block-scaled dot-product unit 200 such that, for example, 0 is added to the sum of the products from multipliers 230 to produce a scaled sum 895. Additionally, based on a bit 845 indicating that the native blocks being multiplied by a corresponding block-scaled dot-product unit 200 do share scaling factors 120 with native blocks multiplied by one or more other previous block-scaled dot-product units 200 in the same row 725, an associated multiplexer 238 provides a respective previous scaled sum 835 to product summing circuitry 232 of the corresponding block-scaled dot-product unit such that, for example, the previous scaled sum 835 is added to the sum of the products from multipliers 230 to produce a scaled sum 895.

Further, each block-scaled dot-product unit 200 includes a multiplexer 240-1, 240-2, 240-3, respectively, configured to select between a corresponding fixed value 855-1, 855-2, 855-3 (e.g., fixed value 255) and corresponding scaling factors for current blocks 865-1, 865-2, 865-3, based on a respective bit 875-1, 875-2, 875-3. A Bit 875, for example, indicates whether scaling factors 120 are to be applied to a respective scaled sum 895-1, 895-2, 895-3 by a corresponding block-scaled dot-product unit 200. Based on a bit 875 indicating that scaling factors 120 are not to be applied to a scaled sum 895, an associated multiplexer 240-1, 240-2, 240-3 provides a respective fixed value 855-1, 855-2, 855-3 to the post-dot-product scaling circuitry 234 of a corresponding block-scaled dot-product unit 200 such that no scaling factors 120 are applied to the corresponding scaled sum 895. Further based on a bit 875 indicating that scaling factors 120 are to be applied to a corresponding scaled sum 895, an associated multiplexer 240-1, 240-2, 240-3 provides respective scaling factors for current blocks 865-1, 865-2, 865-3 to the post-dot-product scaling circuitry 234 of the corresponding block-scaled dot-product unit 200 such that the scaling factors for current blocks 865 are applied to the corresponding scaled sum 895 to produce an unscaled sum provided to the floating point summing circuitry 236 of the corresponding block-scaled dot-product unit 200.

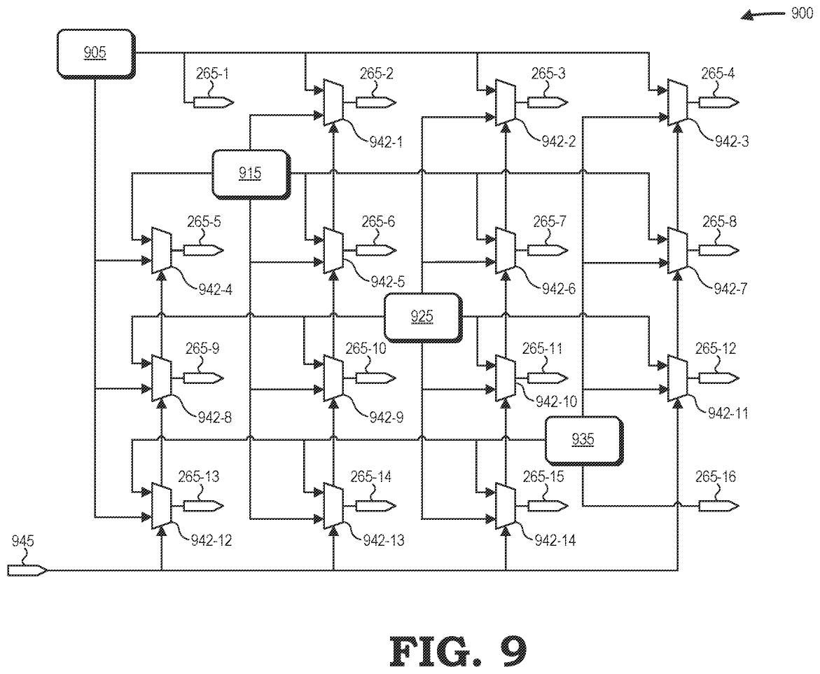

Referring now to FIG. 9, an example scaling factor distribution circuitry 900 is presented, in accordance with some implementations. According to implementations, scaling factor distribution circuitry 900 is implemented in processing system 100 as one or more instances of scaling factor distribution circuitry 118. In implementations, example scaling factor distribution circuitry 900 is configured to switch an instance of block-scaled dot-product circuitry 116 from a first configuration (e.g., example configuration 400) configured to determine a dot product of matrices one-dimensionally blocked (e.g., partitioned into one-dimensional native blocks) and a second configuration (e.g., example configuration 700) configured to determine a dot product of matrices multi-dimensionally blocked (e.g., portioned into multi-dimensional native blocks). To this end, example scaling factor distribution circuitry 900 is configured to distribute a first set of scaling factors 905, a second set of scaling factors 915, a third set of scaling factors 925, and a fourth set of scaling factors 935 among the block-scaled dot-product units 200 included in the block-scaled dot-product circuitry 116. For example, example scaling factor distribution circuitry 900 is configured to distribute scaling factors from the first set of scaling factors 905, second set of scaling factors 915, third set of scaling factors 925, and fourth set of scaling factors 935 to the block-scaled dot-product units 200 such that the scaling factors for current blocks (265-1, 265-2, 265-3, 265-4, 265-5, 265-6, 265-7, 265-8, 265-9, 265-10, 265-11, 265-12, 265-13, 265-14, 265-15, 265-16) provided to the post-dot-product scaling circuitry 234 of each block-scaled dot-product units 200 is from the first set of scaling factors 905, second set of scaling factors 915, third set of scaling factors 925, or fourth set of scaling factors 935.

As an example, when block-scaled dot-product circuitry 116 is in a first configuration, each row (e.g., row 500) of block-scaled dot-product units 200 is configured to determine the dot product of a first row of a first one-dimensionally blocked matrix and a first column of a second one-dimensionally blocked matrix. To facilitate this first configuration, scaling factor distribution circuitry 900 is configured to distribute the first set of scaling factors 905, second set of scaling factors 915, third set of scaling factors 925, and fourth set of scaling factors 935 such that the same set of scaling factors is provided to each block-scaled dot-product units 200 in a row of the first configuration. As an example, scaling factor distribution circuitry 900 is configured to provide the first set of scaling factors 905 to each block-scaled dot-product units 200 in a first row as scaling factors for current blocks 265-1, 265-2, 265-3, and 265-4; provide the second set of scaling factors 915 to each block-scaled dot-product units 200 in a second row as scaling factors for current blocks 265-5, 265-6, 265-7, and 265-8; provide the third set of scaling factors 925 to each block-scaled dot-product units 200 in a third row as scaling factors for current blocks 265-9, 265-10, 265-11, and 265-12; and provide the fourth set of scaling factors 935 to each block-scaled dot-product units 200 in a fourth row as scaling factors for current blocks 265-13, 265-14, 265-15, and 265-16.

As another example, when block-scaled dot-product circuitry 116 is in a second configuration, each column (e.g., column 800) of block-scaled dot-product units 200 is configured to determine the dot products of at least a portion of each row of a multi-dimensionally blocked matrix and at least a portion of a first column of a second multi-dimensionally blocked matrix. To facilitate this second configuration, scaling factor distribution circuitry 900 is configured to distribute the first set of scaling factors 905, second set of scaling factors 915, third set of scaling factors 925, and fourth set of scaling factors 935 such that the same set of scaling factors is provided to each block-scaled dot-product units 200 in a column of the first configuration. As an example, scaling factor distribution circuitry 900 is configured to provide the first set of scaling factors 905 to each block-scaled dot-product units 200 in a first column as scaling factors for current blocks 265-1, 265-5, 265-9, and 265-13; provide the second set of scaling factors 915 to each block-scaled dot-product units 200 in a second column as scaling factors for current blocks 265-2, 265-6, 265-10, and 265-14; provide the third set of scaling factors 925 to each block-scaled dot-product units 200 in a third column as scaling factors for current blocks 265-3, 265-7, 265-11, and 265-15; and provide the fourth set of scaling factors 935 to each block-scaled dot-product units 200 in a fourth column as scaling factors for current blocks 265-4, 265-8, 265-12, and 265-16.

To distribute the sets of scaling factors 905, 915, 925, 935 to the block-scaled dot-product units 200 as scaling factors for current blocks 265, scaling factor distribution circuitry 900 includes multiplexers 942-1, 942-2, 942-3, 942-4, 942-5, 942-6, 942-7, 942-8, 942-9, 942-10, 942-11, 942-12, 942-13, 942-14 each configured to select between two of the sets of scaling factors 905, 915, 925, 935 to provide as respective scaling factors for current blocks 265. As an example, in the implementation presented in FIG. 9, multiplexer 942-1 is configured to select between the first set of scaling factors 905 and the second set of scaling factors 915. Each multiplexer 942, for example, is configured to select between two of the sets of scaling factors 905, 915, 925, 935 based on mode selection bit 945 which indicates whether block-scaled dot-product circuitry 116 is to be in a first configuration to handle one-dimensionally blocked matrices or a second configuration to handle two-dimensionally blocked matrices. As an example, mode selection bit 945 having a first value (e.g., 1) indicates block-scaled dot-product circuitry 116 is to be in a first configuration to handle one-dimensionally blocked matrices and mode selection bit 945 having a second value (e.g., 0) indicates block-scaled dot-product circuitry 116 is to be in a second configuration to handle multi-dimensionally blocked matrices.

In implementations, when selection bit 945 has a first value (e.g., 1) indicating block-scaled dot-product circuitry 116 is to be in a first configuration to handle one-dimensionally blocked matrices, each multiplexer 942 is configured to select between two of the sets of scaling factors 905, 915, 925, 935 such that each block-scaled dot-product unit 200 in each row (e.g., row 500) is provided the same set of scaling factors 905, 915, 925, 935 as respective scaling factors for current blocks 265. Further, when mode selection bit 945 has a second value (e.g., 0) indicating block-scaled dot-product circuitry 116 is to be in a second configuration to handle multi-dimensionally blocked matrices, each multiplexer 942 is configured to select between two of the sets of scaling factors 905, 915, 925, 935 such that each block-scaled dot-product unit 200 in each column (e.g., column 800) is provided the same set of scaling factors 905, 915, 925, 935 as respective scaling factors for current blocks 265. By having the multiplexers 942 distribute the sets of scaling factors 905, 915, 925, 935 in this way based on mode selection bit 945, scaling factor distribution circuitry 900 is configured to switch block-scaled dot-product circuitry 116 between a first configuration to handle one-dimensionally blocked matrices and a second configuration to handle multi-dimensionally blocked matrices (e.g., between a first mode and a second mode).

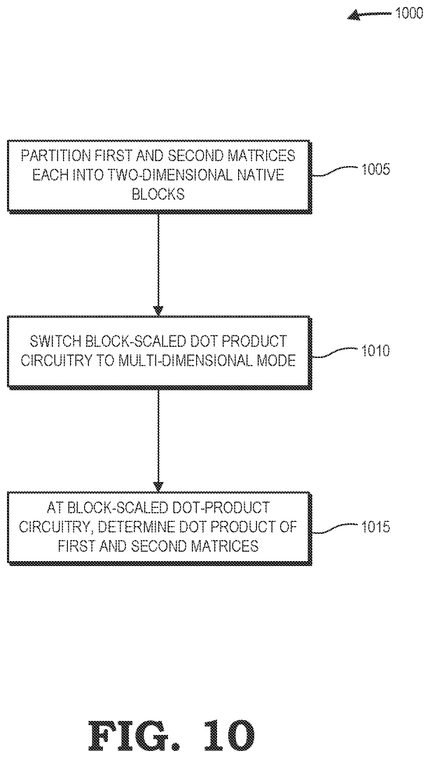

Referring now to FIG. 10, an example method 1000 for determining dot products of multi-dimensional block-scaled matrices is provided, in accordance with some implementations. According to implementations, method 1000 is implemented by AU 112 in processing system 100. In implementations, at block 1005 of example method 1000, AU 112 is configured to first partition a first matrix and a second matrix each into one or more multi-dimensional native blocks. For example, in some implementations, AU 112 is configured to receive one or more instructions, commands, draw calls, or any combination thereof from an application 108 indicating one or more matrices to be multiplied, multi-dimensional application blocks in which to partition the matrices, multi-dimensional native blocks in which to partition the matrices, or any combination thereof. Based on these instructions, block-scaled dot-product circuitry 116 of AU 112 then partitions the first matrix and the second matrix into one or more multi-dimensional application blocks (e.g., application blocks 615, 640), one or more multi-dimensional native blocks (e.g., native blocks 610), or both. As an example, in some implementations, block-scaled dot-product circuitry 116 partitions the first and second matrices each into one or more multi-dimensional application blocks each including two or more multi-dimensional native blocks. As another example, block-scaled dot-product circuitry 116 partitions the first and second matrices each into one or more multi-dimensional native blocks.

After partitioning the first and second matrices each into one or more multi-dimensional application blocks, multi-dimensional native blocks, or both, at block 1010, AU 112 is configured to switch block-scaled dot-product circuitry 116 to a second configuration (e.g., example configuration 700) configured to handle multi-dimensionally blocked matrices. To this end, at block 1010, scaling factor distribution circuitry 118 of AU 112 is configured to distribute one or more sets of scaling factors (e.g., sets of scaling factors 905, 915, 925, 935) to each block-scaled dot-product unit 200 of block-scaled dot-product circuitry 116 such that each column (e.g., column 800) of block-scaled dot-product units 200 receives the same set of scaling factors. After switching block-scaled dot-product circuitry 116 to the second configuration, at block 1015, block-scaled dot-product circuitry 116 determines at least a portion of the dot product of the first matrix and the second matrix. As an example, block-scaled dot-product circuitry 116 is configured to determine dot products for each row of the first matrix and a first column of the second matrix. To this end, in some implementations, each column of block-scaled dot-product units 200 within block-scaled dot-product circuitry 116 is configured to determine partial dot products for each row of the first matrix and a first column of the second matrix. Block-scaled dot-product circuitry 116 then adds these partial dot products along each row of block-scaled dot-product units 200 within block-scaled dot-product circuitry 116 so as to determine dot products for each row of the first matrix and a first column of the second matrix.

In some implementations, the apparatus and techniques described above are implemented in a system including one or more integrated circuit (IC) devices (also referred to as integrated circuit packages or microchips), such as the AU described above with reference to FIGS. 1-10. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still, further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An acceleration unit (AU), comprising:
one or more processor cores; and
a block-scaled dot-product circuitry configured to:
partition a first matrix and a second matrix each into one or more multi-dimensional scaled blocks; and
multiply the first matrix by the second matrix by determining a dot product of at least a portion of a first multi-dimensional scaled block of the first matrix and at least a portion of a first multi-dimensional scaled block of the second matrix.

2. The AU of claim 1, wherein the block-scaled dot-product circuitry includes:
a plurality of block-scaled dot-product units arranged into a plurality of columns, wherein each column of the plurality of columns is configured to determine a dot product of at least a portion of each row of the first matrix and at least a portion of a first column of the second matrix.

3. The AU of claim 2, wherein the plurality of block-scaled dot-product units is further arranged in a plurality of rows and wherein each row of the plurality of rows is configured to determine a dot product of a corresponding row of the first matrix and the first column of the second matrix.

4. The AU of claim 1, wherein the block-scaled dot-product circuitry is configured to operate in a first configuration to handle matrices partitioned into one-dimensional scaled blocks and a second configuration to handle matrices partitioned into multi-dimensional scaled blocks.

5. The AU of claim 4, further comprising:
a scaling factor distribution circuitry configured to switch the block-scaled dot-product circuitry between the first configuration and the second configuration.

6. The AU of claim 1, wherein the second matrix comprises a transposed matrix.

7. The AU of claim 1, wherein the one or more multi-dimensional scaled blocks of the first matrix and the one or more multi-dimensional scaled blocks of the second matrix each comprises a multi-dimensional application block including two or more multi-dimensional native blocks.

8. A method, comprising:
partitioning a first matrix and a second matrix each into one or more multi-dimensional scaled blocks; and
multiplying, at a block-scaled dot-product circuitry, the first matrix by the second matrix by determining a dot product of at least a portion of a first multi-dimensional scaled block of the first matrix and at least a portion of a first multi-dimensional scaled block of the second matrix.

9. The method of claim 8, wherein the block-scaled dot-product circuitry includes:
a plurality of block-scaled dot-product units arranged into a plurality of columns, wherein each column of the plurality of columns is configured to determine a dot product of at least a portion of each row of the first matrix and at least a portion of a first column of the second matrix.

10. The method of claim 9, wherein the plurality of block-scaled dot-product units is further arranged in a plurality of rows and wherein each row of the plurality of rows is configured to determine a dot product of a corresponding row of the first matrix and the first column of the second matrix.

11. The method of claim 8, wherein the block-scaled dot-product circuitry is configured to operate in a first configuration to handle matrices partitioned into one-dimensional scaled blocks and a second configuration to handle matrices partitioned into multi-dimensional scaled blocks.

12. The method of claim 11, further comprising:
switching the block-scaled dot-product circuitry between the first configuration and the second configuration.

13. The method of claim 8, wherein the partitioned first matrix is configured to be on a first side of an operand for a first multiplication operation and a second side of the operand for a second multiplication operation, wherein the first side is different from the second side.

14. The method of claim 8, wherein the one or more multi-dimensional scaled blocks of the first matrix and the one or more multi-dimensional scaled blocks of the second matrix each comprises a multi-dimensional application block including two or more multi-dimensional native blocks.

15. A processing system, including:
a memory storing one or more instructions; and
an acceleration unit (AU) coupled to the memory and configured to:
partition a first matrix and a second matrix each into one or more multi-dimensional scaled blocks based on the one or more instructions; and
multiply the first matrix by the second matrix based on the one or more multi-dimensional scaled blocks of the first matrix and the one or more multi-dimensional scaled blocks of the second matrix.

16. The processing system of claim 15, wherein the AU includes:
a plurality of block-scaled dot-product units arranged into a plurality of columns, wherein each column of the plurality of columns is configured to determine a dot product of at least a portion of each row of the first matrix and at least a portion of a first column of the second matrix.

17. The processing system of claim 16, wherein the plurality of block-scaled dot-product units is further arranged in a plurality of rows and wherein each row of the plurality of rows is configured to determine a dot product of a corresponding row of the first matrix and the first column of the second matrix.

18. The processing system of claim 16, wherein each block-scaled dot-product unit of the plurality of block-scaled dot-product units is configured to determine a dot product of at least a portion of a multi-dimensional scaled block of the one or more multi-dimensional blocks of the first matrix and at least a portion of a multi-dimensional scaled block of the one or more multi-dimensional blocks of the second matrix.

19. The processing system of claim 15, wherein the second matrix comprises a transposed matrix.

20. The processing system of claim 15, wherein the one or more multi-dimensional scaled blocks of the first matrix and the one or more multi-dimensional scaled blocks of the second matrix each comprises a multi-dimensional application block including two or more multi-dimensional native blocks.
